(19) United States
(12) Patent Application Publication
(10) Pub. No.: US 2008/0239351 A1
(43) Pub. Date: Oct. 2, 2008

(54) IMAGE PROCESSING DEVICE, PRINTING DEVICE, SEARCH DEVICE, AND IMAGE PROCESSING METHOD

(75) Inventor: Junya YADA, Shiojiri-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/056,142

(22) Filed: Mar. 26, 2008

(30) Foreign Application Priority Data
Mar. 28, 2007 (JP) 2007-083378

(51) Int. Cl. H04N 1/40

(52) U.S. Cl. 358/1.9; 358/3.13

(57) ABSTRACT

A circuit structure has multiple comparator circuits connected in series. Each comparator circuit compares an input tone value with a medium value of table data input from a preceding comparator circuit. When the tone value is greater than the medium value, the comparator circuit selects table data of greater than the medium value and outputs the selected table data to a subsequent comparator circuit. In this state, the comparator circuit outputs a value ‘1’ as a resulting bit representing a result of the comparison. When the tone value is not greater than the medium value, on the other hand, the comparator circuit selects table data of not greater than the medium value and outputs the selected table data to the subsequent comparator circuit. In this state, the comparator circuit outputs a value ‘0’ as the resulting bit. The circuit structure arrays the resulting bits output from the respective comparator circuits in an output order from its upper bit position and outputs the array of the resulting bits.

### CLAIM OF PRIORITY

The present application claims the priority based on Japanese Patent Application No. 2007-83378 filed on Mar. 28, 2007, the disclosure of which is hereby incorporated by reference in its entirety.

### BACKGROUND

1. Technical Field

The present invention relates to a technique of forming dots to print an image on a printing medium.

2. Related Art

Printing devices of forming dots to print an image on a printing medium have widely been used as an image output device for various images, for example, images generated by computers and images taken by digital cameras.

With regard to dot formation, the image processing technique disclosed in US-A-2006-285165 implements the halftoning process by sequentially referring to various tables prepared in advance.

There would be a demand for enabling desired data to be efficiently obtained from a table used for the halftoning process.

### SUMMARY

The present invention accomplishes at least part of the above and other related demands by the following configuration.

One aspect of the invention pertains to an image processing device of determining an arrangement of dots, based on a dither matrix having a record of threshold values used for determining a dot formation state in each of pixels constituting image data according to a tone value the pixel.

The image processing device includes: an encoding table generation module configured to divide the dither matrix into multiple blocks, each including a preset number of plural threshold values, and sequentially compare each tone value with threshold values included in each block in an allowable range of the tone value in an ascending order, so as to generate an encoding table of recording a correlation of an encoded value representing an arrangement of dots in one block to a representative tone value; an image data input module configured to input image data; a block position identification module configured to identify a block position in the dither matrix corresponding to each pixel, based on a position of the pixel in the input image data and positions of the respective blocks in the dither matrix; a table data input module configured to input a tone value of each pixel as a comparison target value and input a numeric sequence of multiple representative tone values correlated to a block position identified corresponding to the pixel from the encoding table; a comparison module configured to compare the comparison target value of each pixel with a medium value (median) of the numeric sequence correlated to the identified block position and repeat comparison between the comparison target value with a successively specified medium value of the numeric sequence while sequentially halving the number of the representative tone values included in the numeric sequence on a boundary of the medium value; an encoding module configured to specify an encoded value of each pixel according to a result of the repeated comparisons; and a decoding module configured to determine an arrangement of dots to be formed in a block corresponding to the position of each pixel, based on the specified encoded value of the pixel and the identified block position.

The image processing device according to this aspect of the invention repeats the comparison between a tone value in each of pixels constituting an image with a medium value of a numeric sequence of multiple representative tone values correlated to an identified block position corresponding to the pixel and input from the encoding table, while successively halving the number of the representative tone values included in the numeric sequence. The encoded value representing an arrangement of dots to be created in one block at the identified block position is specified according to the result of each comparison. This arrangement enables a desired encoded value to be efficiently obtained from the encoding table.

The technique of the invention is not restricted to the image processing device described above but may also be applied to an image processing method and corresponding computer program. The computer program may be recorded in a computer readable recording medium. Typical examples of the recording medium include flexible disks, CD-ROMs, DVD-ROMs, magneto-optical disks, memory cards, and hard disks.

These and other objects, features, aspects, and advantages of the invention will become more apparent from the following detailed description of the preferred embodiments with the accompanying drawings.

### BRIEF DESCRIPTION OF THE DRAWINGS

FIG. 1 schematically illustrates the appearance of a printer according to one embodiment of the invention;

FIG. 2 shows the internal structure of the printer of the embodiment;

FIG. 3 shows the detailed structure of an image processing ASIC included in the printer;

FIG. 4 shows one example of dot array data;

FIG. 5 is a flowchart showing a printing process performed in the printer of the embodiment;

FIG. 6 is a flowchart showing the details of an initialization process executed at step S10 in the printing process of FIG. 5;

FIG. 7 shows the data structure of dither matrix data DM and a process of generating an ordinal number table ST;

FIG. 8 shows one example of a post-decoding table DT2;

FIG. 9 shows one example of a dot formation amount table DGT;

FIG. 10 shows the data structure of an encoding table ET;

FIG. 11 shows the data structure of a pre-decoding table DT1;

FIG. 12 is a flowchart showing the details of a table generation process of the encoding table ET and the pre-decoding table DT1 executed at step S140 in the initialization process of FIG. 6;

FIG. 13 is a flowchart showing the details of a dot number counting process executed at step S240 in the table generation process of FIG. 12;

FIG. 14 shows a concrete example of the dot number counting process;

FIG. 15 is a flowchart showing the details of a halftoning process executed at step S40 in the printing process of FIG. 5;

FIG. 16 is a flowchart showing the details of an encoding process executed at step S800 in the halftoning process of FIG. 15;

FIG. 17 is a conceptual view showing one method of computing a block number corresponding to a target pixel;

FIG. 18 is a conceptual view showing another method of computing the block number corresponding to the target pixel;

FIG. 19 is a flowchart showing the details of a decoding process executed at step S840 in the halftoning process of FIG. 15;

FIG. 20 is a flowchart showing the details of a dot arrangement process executed at step S830 in the decoding process of FIG. 19;

FIG. 21 shows a concrete example of the dot arrangement process;

FIG. 22 shows the schematic structure of an encoded value search unit provided in the image processing ASIC;

FIG. 23 is a circuit block diagram of a first comparator included in the encoded value search unit;

FIG. 24 is a circuit block diagram of a second comparator included in the encoded value search unit;

FIG. 25 is a circuit block diagram of a third comparator included in the encoded value search unit;

FIG. 26 is a circuit block diagram of a fourth comparator included in the encoded value search unit;

FIG. 27 is a circuit block diagram of a fifth comparator included in the encoded value search unit; and

FIG. 28 shows a concrete example of determining an encoded value by the encoded value search unit.

### DESCRIPTION OF THE PREFERRED EMBODIMENTS

In order to elucidate the functions and the advantages of the invention, some modes of carrying out the invention are described below in the following sequence with reference to the accompanied drawings:

(A) Structure of Printer

(B) Printing Process

(C) Initialization Process

(D) Halftoning Process
(D-1) Encoding Process
(D-2) Decoding Process

(E) Another Method of Encoding Process

(F) Other Aspects

### (A) Structure of Printer

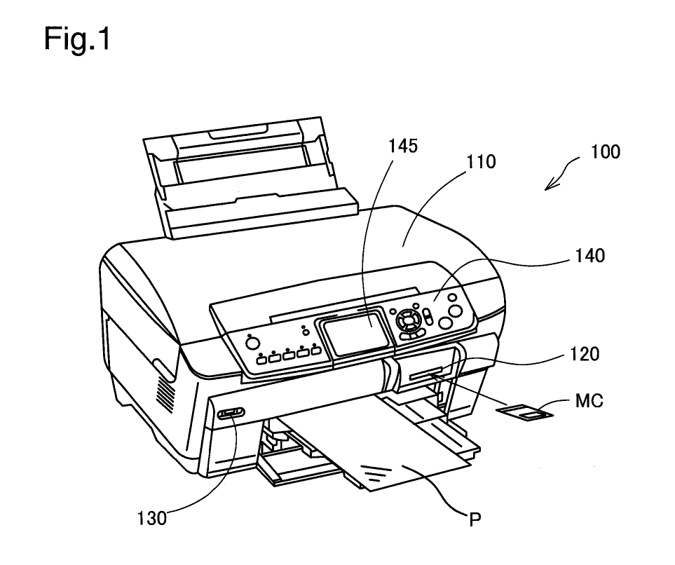

FIG. 1 schematically illustrates the appearance of a printer 100 according to one embodiment of the invention. The printer 100 is constructed as a multifunction printing device and includes a scanner 110 functioning to optically read images, a memory card slot 120 functioning to receive an inserted memory card MC having a record of image data, and a USB interface 130 functioning to make connection with an external device, such as a digital camera. The printer 100 is operated to print various images, for example, images taken in by the scanner 110, images read from the memory card MC, and images read from the digital camera via the USB interface 130, on printing paper P. The printer 100 is also capable of printing images input from a personal computer (not shown) connected by a printer cable or any other suitable means.

The printer 100 has an operation panel 140 operated for various printing-related settings, for example, selection of each desired image as a print object and settings of the type and size of printing paper P. The operation panel 140 has a liquid crystal monitor 145 in its center area. Lists of images input from, for example, the memory card MC and various graphical interfaces (GUI) are displayed on the liquid crystal monitor 145.

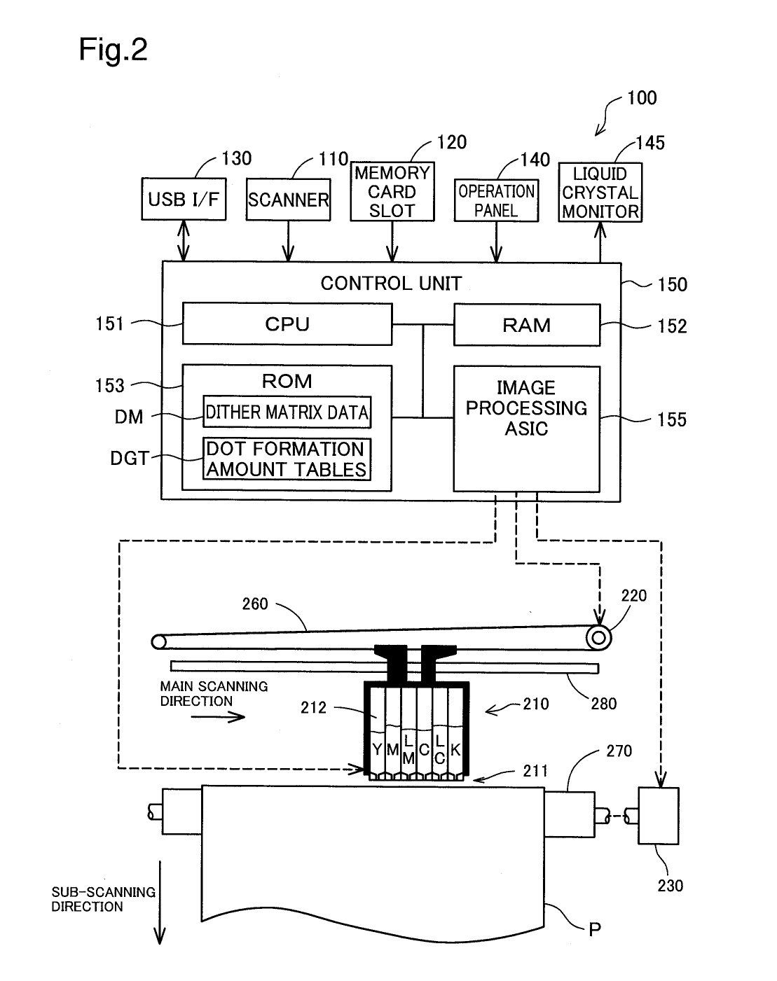

FIG. 2 shows the internal structure of the printer 100. As illustrated, the printer 100 has a carriage 210 equipped with ink cartridges 212 thereon, a carriage motor 220 for driving the carriage 210 in a main scanning direction, and a paper feed motor 230 for feeding the printing paper P in a sub-scanning direction as a printing mechanism for printing on the printing paper P.

The ink cartridges 212 mounted on the carriage 210 respectively contain color inks, cyan (C), light cyan (Lc), magenta (M), light magenta (Lm), yellow (Y), and black (K). The carriage 210 has six ink heads 211 corresponding to these six color inks. A supply of each color ink fed from the ink cartridge 212 to the ink head 211 is ejected on the printing paper P by actuation of piezoelectric elements (not shown) provided in the ink head 211.

A control unit 150 included in the printer 100 regulates voltage waveforms applied to the piezoelectric elements of the ink head 211 to attain four different states of dot formation. The four different states of dot formation correspond to creation of three different size dots (small-size dot, medium-side dot, and large-size dot) and creation of no dot on the printing paper P. In the description below, the creation of no dot and the created three different size dots are expressed as “non-dot”, ‘S dot’, ‘M dot’, and ‘L dot’ in a dot-size ascending order. The S dot, the M dot, and the L dot are respectively formed by ink quantities of 1.5 pl (picoliters), 3 pl, and 7 pl per dot. The printer 100 of this embodiment is capable of attaining these four different states of dot formation. This is, however, not restrictive, and the printer may be designed to attain two, three, five or any greater number of different states of dot formation.

The carriage 210 is held in a freely movable manner on a sliding shaft 280 that is arranged in parallel to an axial direction of a platen 270. The carriage motor 220 rotates a drive belt 260 in response to a command from the control unit 150 to move back and forth the carriage 210 in a direction parallel to the axial direction of the platen 270, that is, in the main scanning direction. The paper feed motor 230 rotates the platen 270 in response to a command from the control unit 150 to feed the printing paper P in a direction perpendicular to the axial direction of the platen 270, that is, in the sub-scanning direction.

The printer 100 has the control unit 150 that controls the operations of the ink heads 211, the carriage motor 220, and the paper feed motor 230. The control unit 150 is connected with the scanner 110, the memory card slot 120, the USB interface 130, the operation panel 140, and the liquid crystal monitor 145 shown in FIG. 1.

The control unit 150 includes a CPU 151, a RAM 152, a ROM 153, and an image processing ASIC 155.

The ROM 153 stores a control program executed to generally control the operations of the printer 100. The CPU 151 loads and executes the control program on power supply of the printer 100. The CPU 151 performs a printing process and an initialization process (described later) according to this control program.

The ROM 153 stores dither matrix data DM and dot formation amount tables DGT used in the initialization process, in addition to the control program. The RAM 152 stores various tables generated in the initialization process.

The image processing ASIC 155 is an integrated circuit that causes image data input from, for example, the memory card MC, to be subjected to a color conversion process and a halftoning process and controls the printing mechanism (the ink heads 211, the carriage motor 220, and the paper feed motor 230) to implement printing. Logic circuits in the image processing ASIC 155 are constructed by programs written in a predetermined hardware description language to attain various functions described below.

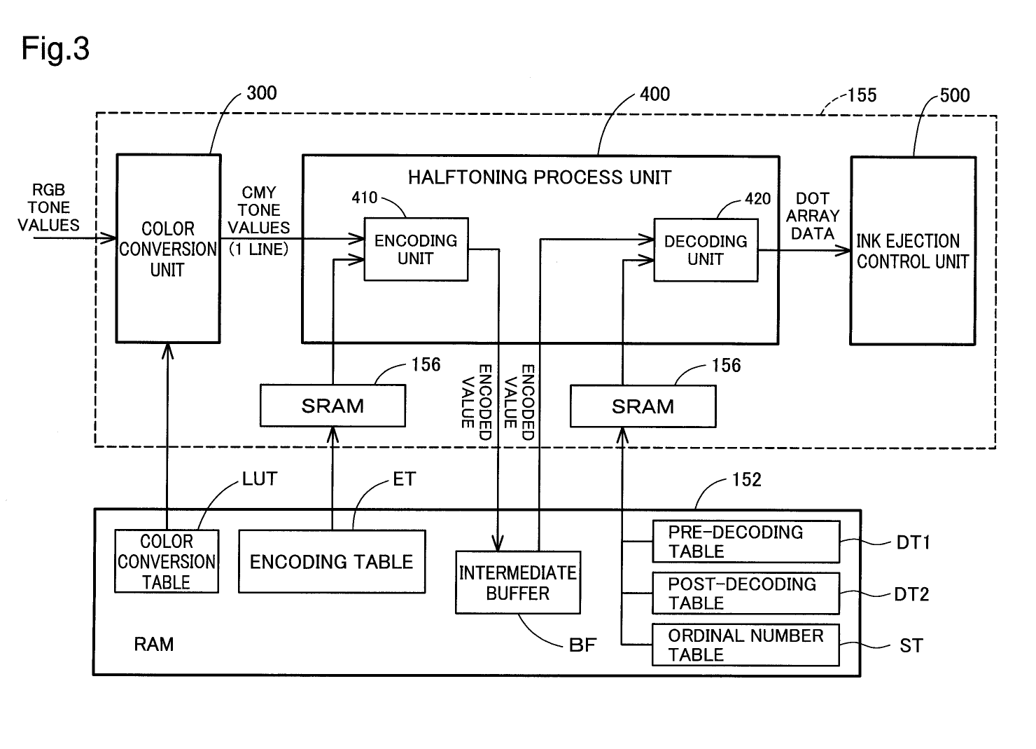

FIG. 3 shows the detailed structure of the image processing ASIC 155. As illustrated, the image processing ASIC 155 of this embodiment includes a color conversion unit 300, a halftoning process unit 400, and an ink ejection control unit 500.

The color conversion unit 300 is a circuit of converting the color of image data expressed by a combination of tone values of three primary colors R, G, and B into the color expressed by a combination of tone values of the respective color inks provided on the carriage 210. As mentioned above, the printer 100 of the embodiment uses the six color inks C, M, Y, K, Lc, and Lm to print an image. The color conversion unit 300 accordingly converts image data expressed by the R, G, and B tone values into image data expressed by the tone values of these six color inks.

The color conversion unit 300 refers to a color conversion table LUT stored in the RAM 152 to perform such color conversion. The color conversion table LUT stores a correlation of R, G, and B tone values to C, M, Y, K, Lc, and Lm tone values. The color conversion unit 300 readily converts image data expressed in the RGB format into image data in the CMYKLcLm format (hereafter referred to as ‘CMY format’) by simply referring to this color conversion table LUT. The color-converted image data is expressed by tone values in 256 stages (0 to 255) with regard to each color.

The halftoning process unit 400 is a circuit that inputs the image data in the CMY format after color conversion by the color conversion unit 300 and converts the input image data into dot array data representing an arrangement of dots to be created on the printing paper P.

The printer 100 is capable of varying the size of each ejected ink droplet only in four different stages at the maximum. The image data in the CMY format of the 256 tones with regard to each color is thus not directly usable in the printer 100. The halftoning process unit 400 of the printer 100 converts the tone values in the CMY format into ‘dot array data’ representing the density of dots per unit area to express halftone colors.

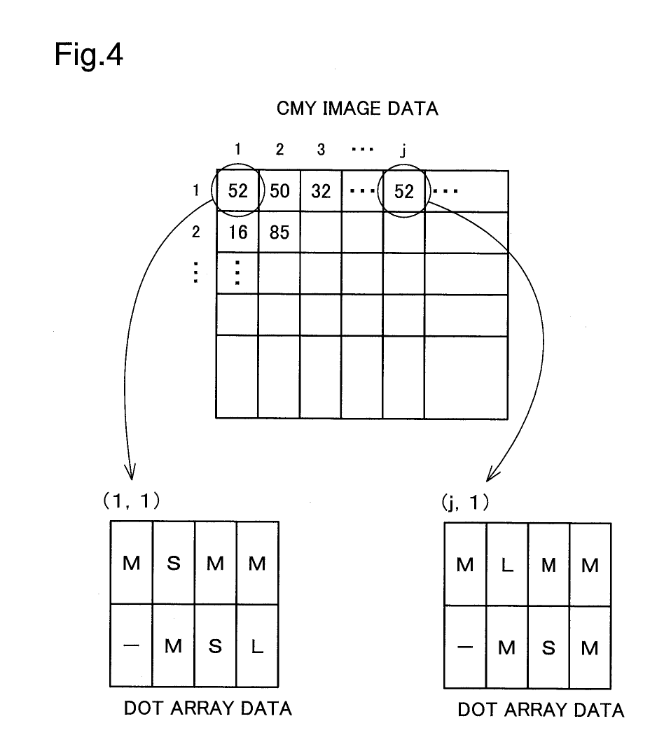

FIG. 4 shows one example of the dot array data. In this illustrated example, an uppermost left pixel (1,1) in the image data in the CMY format (CMY image data) has a tone value ‘52’ with regard to a specific color (for example, cyan). The lower left drawing shows one example of dot array data converted from the tone value of this uppermost left pixel (1,1). In response to input of a tone value in one pixel, S dots, M dots, and L dots are adequately arranged in a dot group of 4×2 dots to express the color corresponding to the tone value on the printing paper P. This dot group may be referred to as a ‘block’ in the description hereafter.

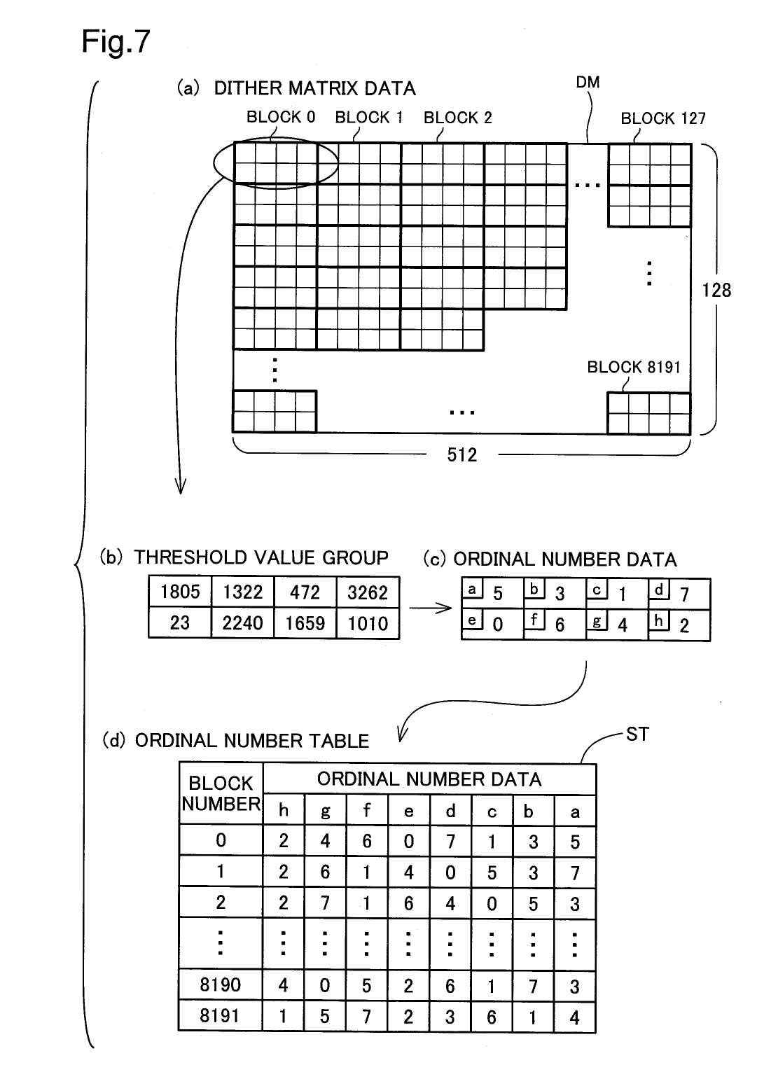

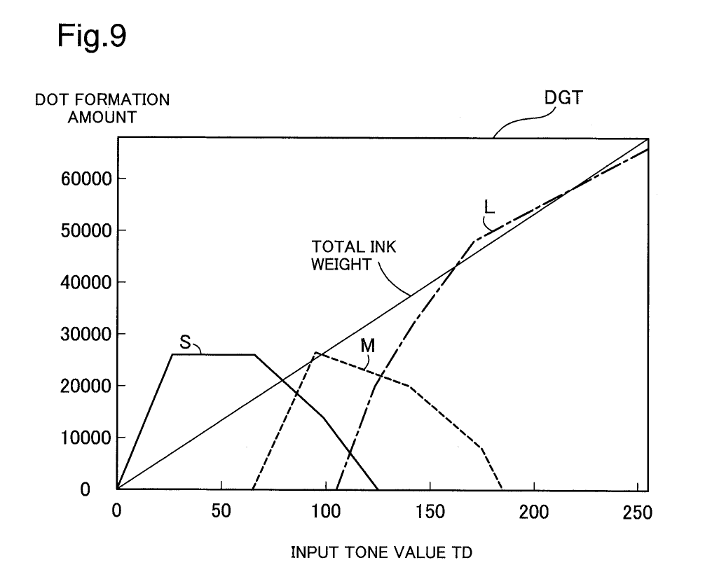

The procedure of generating the dot array data is explained briefly. The arrangement of dots in the dot array data is determined by a correlation of a local threshold value group (see FIG. 7(b)), which is extracted from global dither matrix data DM (see FIG. 7(a)) according to the position of a target pixel as an object of the halftoning process, to dot formation amounts of the respective size dots (see FIG. 9) corresponding to a tone value TD of the target pixel. The procedure refers to the dot formation amount table DGT shown in FIG. 9 to specify the dot formation amounts of the respective size dots corresponding to the input tone value TD, and compares the specified dot formation amounts of the respective size dots with threshold values in the threshold value group. Based on a result of the comparison, the procedure determines the numbers of the respective size dots to be created in one block or dot group corresponding to the target pixel. The respective size dots of the determined numbers are sequentially arranged such that the larger size dot is formed at a position having the lower threshold value in the threshold value group. The dot array data is generated in this manner. The procedure of the embodiment generates in advance multiple tables required for this series of processing, that is, an encoding table ET, a pre-decoding table DT1, a post-decoding table DT2, and an ordinal number table ST. The dot array data is generated efficiently by successively referring to these tables. The detailed processing for generating the dot array data will be described later.

The procedure of this embodiment generates different dot array data for two pixels in CMY image data having an identical tone value, since these two pixels at different positions have different threshold value groups extracted from the global dither matrix data DM shown in FIG. 7(a). In the illustrated example of FIG. 4, the CMY image data includes another pixel (j,1) having the same tone value ‘52’ as that of the uppermost left pixel (1,1). The lower right drawing shows one example of dot array data corresponding to this pixel (j,1). The dot array data corresponding to the pixel (j,1) is different from the dot array data corresponding to the uppermost left pixel (1,1). The procedure of this embodiment varies the generated dot array data for an identical tone value, based on the position of a target pixel as the object of halftoning process. This method enables image output of the higher picture quality, compared with the conventional systematic dither method or the conventional density pattern method.

In this embodiment, the unit of each dot group for an output image is 4×2. When the resolution of an input image is 360 dpi×360 dpi, for example, the resolution of an output image on the printing paper P is 1440 dpi×720 dpi. The output resolution in the lateral direction of the dot group is higher than the output resolution in the vertical direction, since the human eye has the higher following capability to a tone variation in the lateral direction than in the vertical direction. The control of moving the carriage 210 in the main scanning direction is relatively easier than the control of moving the printing paper P in the sub-scanning direction. This is also the reason for the higher resolution in the lateral direction than the resolution in the vertical direction. The size of the dot group is not limited to 4×2 but may have identical vertical and lateral dimensions like 4×4 or 2×2. In the terminology adopted in the description of the embodiment, a ‘pixel’ denotes a minimum constituent unit of an image either in the RGB format or in the CMY format, and a ‘dot’ denotes a minimum constituent unit of an output image formed on the printing paper P. After the resolution of an input image in the RGB format or in the CMY format is enhanced from 360 dpi×360 dpi to 1440 dpi×720 dpi, a preset number of multiple pixels in the high-resolution image are grouped, for example, to a 4×2 pixel block or a 2×2 pixel block. A representative pixel of the pixel block (for example, the representative pixel has an average of the tone values in the respective pixels in the pixel group) may be treated as one ‘pixel’.

Referring back to FIG. 3, the halftoning process unit 400 includes an encoding unit 410 and a decoding unit 420.

Image data in the CMY format (CMY image data) output from the color conversion unit 300 to the halftoning process unit 400 is input into the encoding unit 410. The input unit of the CMY image data into the encoding unit 410 is one line.

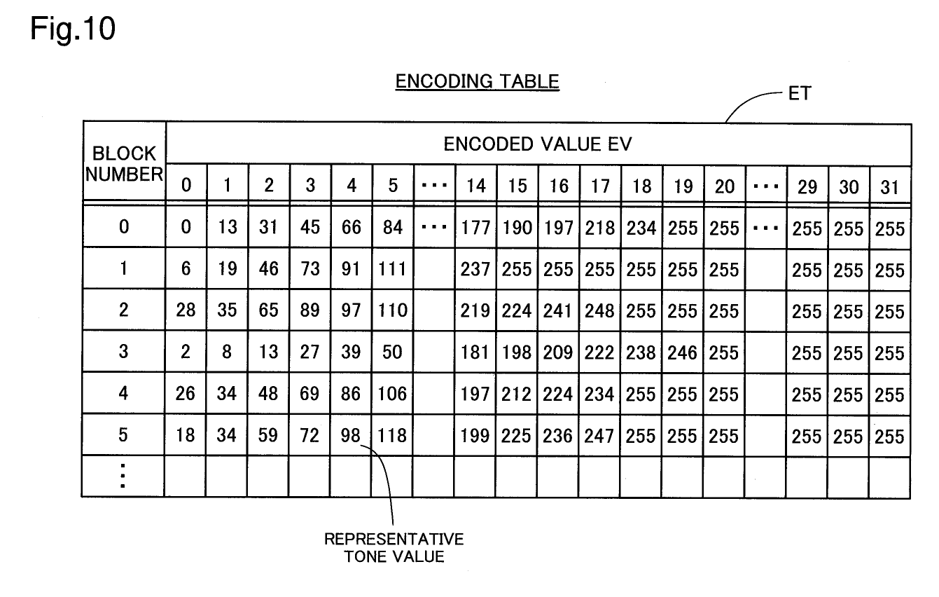

The encoding unit 410 refers to the encoding table data ET (see FIG. 10) stored in the RAM 152 to convert the tone value (8 bit) in each of pixels constituting the CMY image data into an encoded value EV expressed by 5-bit data with regard to each color. Such conversion is hereafter referred to as ‘encoding process’. The encoded value EV obtained by the encoding process indirectly represents the dot array data (see FIG. 4) to be generated on the printing paper P. The terminology ‘indirectly’ is used because the encoded value EV is reconverted according to a corresponding decoding table by a decoding process (described later) to the dot array data. The method of generating the encoding table ET referred to in the encoding process and the detailed procedure of the encoding process will be explained later.

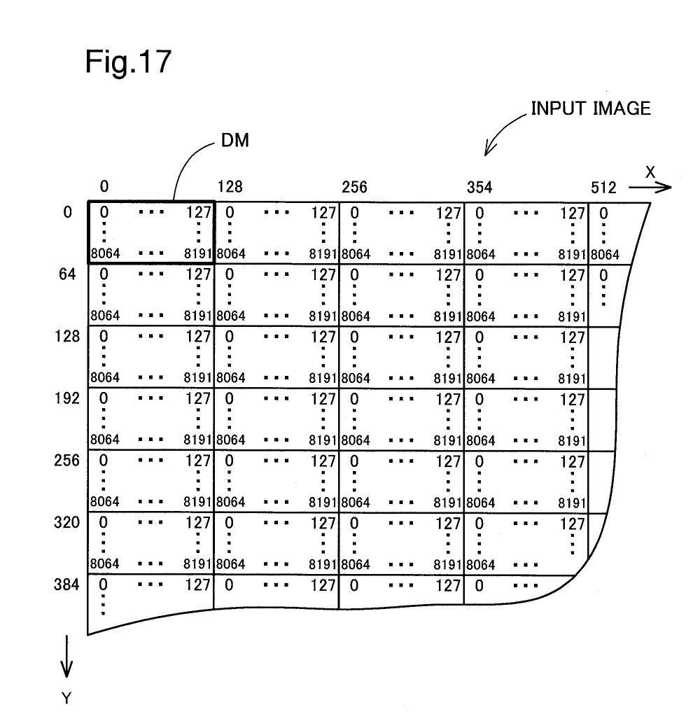

The image processing ASIC 155 internally has an SRAM 156 that enables higher speed read/write operations than the RAM 152 (see FIG. 2). In the process of converting one line of the CMY image data into encoded values EV, the encoding unit 410 extracts data required for encoding the one line of the CMY image data from the encoding table ET stored in the RAM 152 and temporarily inputs the extracted data as the partial encoding table ET in the SRAM 156. The encoding unit 410 refers to this partial encoding table ET input in the SRAM 156 to implement the encoding process. For example, as described later in detail, in the case of encoding an uppermost line in the CMY image data, data corresponding to block numbers 0 to 127 (where maximum block number is ‘8191’) are extracted from the encoding table ET shown in FIG. 10 and are input into the SRAM 156 (see FIG. 17). Part of the blocks in the encoding table ET is repeatedly used in the encoding process of one line. Input of only the required data of the encoding table ET in the internal SRAM 156 of the image processing ASIC 155 enables the efficient encoding process. In the embodiment, the encoding unit 410 performs the encoding process in the unit of one line. This is, however, not restrictive, but the unit of the encoding process may be two or a greater number of lines. The encoding process may otherwise be performed collectively for the whole image.

The encoding unit 410 converts an 8-bit CMY tone value into a 5-bit encoded value EV and buffers the 5-bit encoded value EV into an intermediate buffer BF set in a specific area of the RAM 152. In this manner, the procedure of this embodiment converts 8-bit image data input from the memory card MC into 5-bit data and stores the converted 5-bit data in the RAM 152. This arrangement desirably saves the storage space of the RAM 152 and thereby reduces the cost.

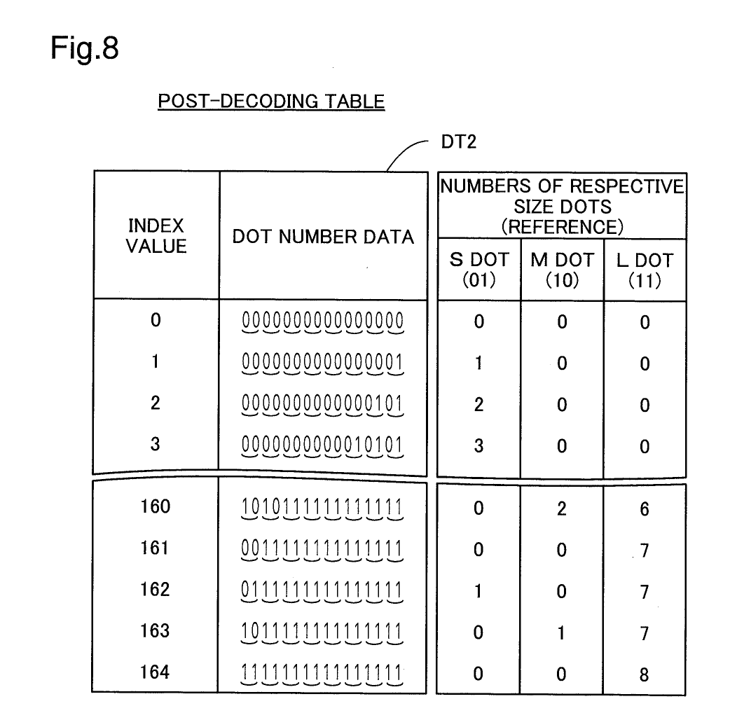

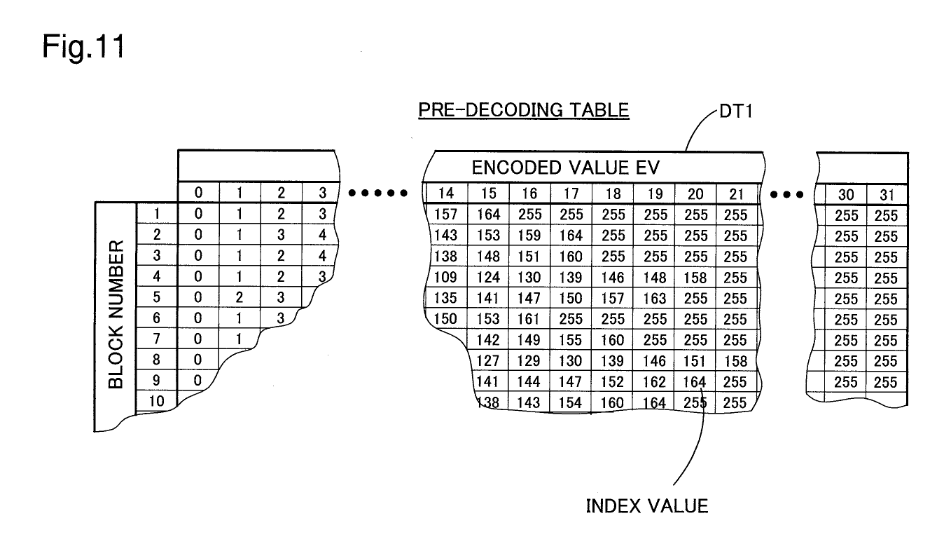

The decoding unit 420 reads the encoded value EV from the intermediate buffer BF and sequentially refers to the pre-decoding table DT1 (see FIG. 11), the post-decoding table DT2 (see FIG. 8), and the ordinal number table ST (see FIG. 7(d)) stored in the RAM 152 to convert the encoded value EV into dot array data of 4×2 dots as shown in FIG. 4. Such conversion is hereafter referred to as ‘decoding process’. The methods of generating the respective tables referred to in the decoding process and the details of the decoding process will be described later. The unit of the decoding process is one line, like the unit of the encoding process. Only the required data extracted from the pre-decoding table DT1 and the ordinal number table ST are accordingly input into the SRAM 156.

The decoding unit 420 outputs the dot array data reconverted from the encoded value EV to the ink ejection control unit 500.

The ink ejection control unit 500 controls the ink heads 211, the carriage motor 220, and the paper feed motor 230 to eject ink droplets and form dots on the printing paper P according to the dot array data input from the halftoning process unit 400. In the dot array data, the respective size dots are expressed by 2-bit data as ‘00 (non-dot)’, ‘01 (S dot)’, ‘10 (M dot)’, and ‘11 (L dot)’. This 2-bit data is hereafter referred to as ‘dot size value’. The ink ejection control unit 500 regulates the voltage waveform to be applied to the piezoelectric element in the ink head 211 corresponding to the dot size value to selectively create one of the respective size dots. The printer 100 of the embodiment accordingly prints a color image on the printing paper P.

### (B) Printing Process

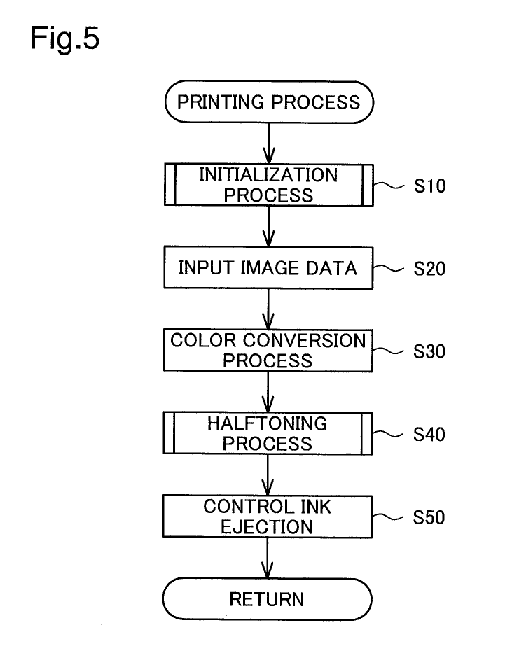

FIG. 5 is a flowchart showing the printing process performed in the printer 100. The CPU 151 executes the printing process in response to the user's preset print operation on the operation panel 140.

In the printing process, the CPU 151 first performs the initialization process to generate the encoding table ET, the pre-decoding table DT1, the post-decoding table DT2, and the ordinal number table ST shown in FIG. 3 (step S10). The details of the initialization process will be explained later.

After the initialization process, the CPU 151 inputs the user's selected image data from, for example, the memory card MC (step S20) and outputs the input image data to the image processing ASIC 155. In the image processing ASIC 155, the color conversion unit 300 performs the color conversion process (step S30), and the halftoning process unit 400 performs the halftoning process (step S40) to generate the dot array data with regard to each pixel of the input image data.

The ink ejection control unit 500 then controls ink ejection according to the dot array data generated by the halftoning process unit 400 (step S50). As the result of this series of processing, a color image is printed on the printing paper P. The details of the halftoning process performed in the image processing ASIC 155 will be described later.

### (C) Initialization Process

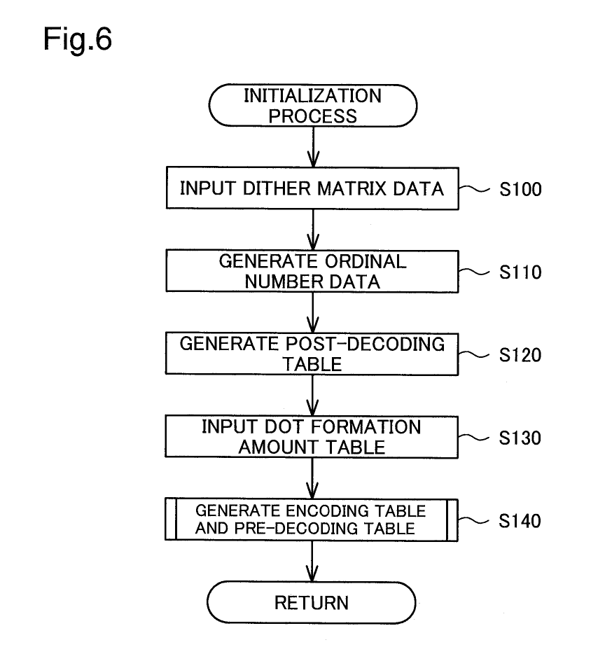

FIG. 6 is a flowchart showing the details of the initialization process executed at step S10 in the printing process of FIG. 5. As mentioned above, the initialization process generates the various tables to be referred to in the halftoning process by the halftoning process unit 400.

In the initialization process, the CPU 151 first inputs the dither matrix data DM from the ROM 153 into the RAM 152 (step S100) and generates the ordinal number data ST according to the input dither matrix data DM (step S110). The ordinal number data ST is used to determine the order of arranging the respective size dots in each 4×2 block in the decoding process described later.

FIG. 7 shows the data structure of the dither matrix data DM and the process of generating the ordinal number table ST. FIG. 7(a) shows the data structure of the dither matrix data DM. In the dither matrix data DM of this embodiment, a total of 65536 threshold values in a range of 0 to 65535 are evenly recorded in an array of 512 in width×128 in length (the threshold values are omitted from the illustration). The dither matrix data DM is constructed as a table equivalent to a dither matrix used in the systematic dither method as the conventionally known halftoning technique. In the dither matrix data DM, the respective threshold values are arranged to enhance the dispersibility of dots in binarization of image data that is assumed to have tone values in the range of 0 to 65535. A typical example of the dither matrix data DM is a matrix having the blue noise characteristic. In the embodiment, the dither matrix DM has the size of 512×128. This size is, however, not restrictive, but the dither matrix DM may have any other suitable size, for example, 128×32 or 1024×256.

At step S110, the ordinal number table ST is generated from the dither matrix data DM. The CPU 151 first divides the dither matrix data DM into a total of 8192 (=(512/4)×(128/2)) threshold value blocks, where each threshold value block has 4×2 threshold values, and allocates a block number to each of the 8192 blocks. In this embodiment, as shown in FIG. 7(a), a block number ‘0’ is allocated to an uppermost left block in the dither matrix data DM, and a block number ‘1’ is allocated to its immediate right block. In this manner, the block numbers are sequentially allocated from the uppermost left block to a lowermost right block.

FIG. 7(b) shows a threshold value group consisting of threshold values recorded in the uppermost left block having the block number ‘0’. FIG. 7(c) shows ordinal number data generated according to this threshold value group. The CPU 151 raises the tone value from 0 to 65535 simultaneously for all the elements in the threshold value group shown in FIG. 7(b) and records the order of the elements (0 to 7) in the threshold value group where the rising tone value exceeds the threshold value set in the element to generate the ordinal number data shown in FIG. 7(c). In the illustrated example of FIG. 7(b), the rising tone value exceeds the threshold value set in the element in the order of the elements having the threshold values ‘23’, ‘472’, ‘1010’, ‘1322’, . . . , ‘3262’. The ordinal number data corresponding to the block number ‘0’ is accordingly given as FIG. 7(c).

The CPU 151 generates the ordinal number data with regard to all the blocks and records the ordinal number data corresponding to the respective block numbers to generate the ordinal number table ST. FIG. 7(d) shows one example of the ordinal number table ST eventually generated by this series of processing. The CPU 151 stores the generated ordinal number table ST in the RAM 152.

Referring back to the flowchart of FIG. 6, after generation of the ordinal number table ST at step S110, the CPU 151 generates the post-decoding table DT2 (step S120), which is to be referred to in the decoding process described later.

FIG. 8 shows one example of the post-decoding table DT2. As illustrated, the post-decoding table DT2 has 16-bit dot number data recorded in correlation to index values from 0 to 164. The dot number data is a combination of eight 2-bit dot size values right-aligned from the larger size dot. The 165 dot number data cover all the possible combinations of the respective size dots created in one block.

There are 165 combinations of the respective size dots created in one block, because of the following reason. As mentioned previously, there are four different states of dot formation, that is, ‘non-dot’, ‘S dot’, ‘M dot’, and ‘L dot’, in each element of one block. The total number of possible combinations of the respective size dots created in one block is accordingly equal to the total number of possible combinations of eight selections out of these four states of dot formation with repetition. The number of possible combinations of the respective size dots is thus expressed by Equation (1) for repeated combinations given below:

₄H₈ (=₄₊₈₋₁C₈)=165 (1)

where ₙHᵣ denotes an operator for determining the number of repeated combinations in r selections out of n elements with repetition, and ₙCᵣ denotes an operator for determining the number of combinations in r selections out of n elements without repetition. This proves that there are only 165 possible combinations (0 to 164) at the maximum. The index values of 0 to 164 are thus sufficient to cover all the dot number data.

The CPU 151 generates the post-decoding table DT2 shown in FIG. 8 according to the following procedure. The CPU 151 first sets a value ‘0’ to all the numbers of the respective size dots, the S dot, the M dot, and the L dot, to be created in one block and records this setting as dot number data corresponding to an index value ‘0’ in the post-decoding table DT2. In this case, all the elements in one block are specified as ‘non-dot (00)’ and the dot number data is accordingly given as ‘0000000000000000’.

The CPU 151 sequentially increases the setting of the number of the S dot from ‘1’ to ‘8’ and records the respective settings as dot number data corresponding to index values ‘1’ to ‘8’ in the post-decoding table DT2. When the number of the S dot is set to ‘1’, the dot number data is equal to ‘0000000000000001’. When the number of the S dot is set to ‘8’, the dot number data is equal to ‘0101010101010101’.

The CPU 151 sets the number of the M dot to a fixed value ‘1’ and increases the setting of the number of the S dot from ‘0’ to ‘7’ under the condition that the total number of dots created in one block is not greater than 8. The respective combinations of the numbers of the S dot and the M dot are recorded as dot number data corresponding to index values of and after ‘9’ in the post-decoding table DT2.

The CPU 151 sets the number of the M dot to a fixed value ‘2’ and increases the setting of the number of the S dot from ‘0’ to ‘6’ under the condition that the total number of dots created in one block is not greater than 8. The respective combinations of the numbers of the S dot and the M dot are recorded as dot number data in the post-decoding table DT2. The post-decoding table DT2 is completed by sequentially changing the numbers of the respective size dots in this manner until the number of the L dot is set to ‘8’. The CPU 151 stores the generated post-decoding table DT2 in the RAM 152. As long as the unique index values are allocated to the respective dot number data, there is no specific definition in their correlation.

Referring back again to the flowchart of FIG. 6, after generation of the post-decoding table DT2 at step S120, the CPU 151 inputs the dot formation amount table DGT, which is used for generation of the encoding table ET and the pre-decoding table DT1 described later, from the ROM 153 into the RAM 152 (step S130).

FIG. 9 shows one example of the dot formation amount table DGT. As illustrated, the dot formation amount table DGT defines the dot formation amounts of the S dot, the M dot, and the L dot as ordinate against the input tone value TD as abscissa. According to this graph, only the S dots are created in a range of the input tone value TD from 0 to about 70, and both the S dots and the M dots are created in a range of the input tone value TD from about 70 to about 120. Creation of the L dots starts at the input tone value TD of about 110. Only the L dots are created in the range of the input tone value TD greater than about 180. The dot formation amount as the ordinate varies from 0 to 65535 to allow the comparison with the threshold values in the dither matrix data DM shown in FIG. 7.

The graph of FIG. 9 shows a variation in total ink weight ejected in creation of the respective size dots on the printing paper P, in addition to the dot formation amounts of the S dot, the M dot, and the L dot. The total ink weight gradually increases with an increase in input tone value TD. The dot formation amounts of the respective size dots are set according to this variation in total ink weight. Multiple different dot formation amount tables DGT are actually provided corresponding to multiple different types of printing papers usable in the printer 100 and are stored in advance in the ROM 153. The respective types of printing papers have characteristic ink absorption rates and light reflectivities, and the dot formation amounts are set corresponding to these characteristics. Namely the CPU 151 inputs the dot formation amount table DGT corresponding to the user's selected type of printing paper P from the ROM 153 into the RAM 152. This ensures printing suitable for the selected printing paper P.

Referring back again to the flowchart of FIG. 6, after input of the dot formation amount table DGT at step S130, the CPU 151 generates the encoding table ET and the pre-decoding table DT1 based on the dot formation amount table DGT and the dither matrix data DM input at step S100 (step S140). In the description hereafter, the processing of step S140 may simply be referred to as ‘table generation process’.

This table generation process is rather complicated. Prior to the detailed description of the table generation process, the data structures of the encoding table ET and the pre-decoding table DT1 generated in the table generation process are explained.

FIG. 10 shows the data structure of the encoding table ET. As illustrated, the encoding table ET records one of tone values of ‘0’ to ‘255’ in correlation to each combination of the block number from ‘0’ to ‘8191’ and the 5-bit encoded value EV from ‘0’ to ‘31’. In the description hereafter, each tone value recorded in the encoding table ET is expressed as a ‘representative tone value’. As explained previously, the encoding table ET is referred to by the encoding unit 410 (see FIG. 3) to convert an 8-bit tone value in each pixel of a CMY image into a 5-bit encoded value EV corresponding to the position of the pixel, that is, the block number.

The conversion from the tone value to the encoded value EV according to the encoding table ET is described briefly. The encoding unit 410 first specifies a block number in the dither matrix data DM corresponding to a target pixel as an object of the encoding process in the CMY image. The encoding unit 410 then refers to a specific row in the encoding table ET corresponding to the specified block number and sequentially compares the tone value of the target pixel with the representative tone values in the specific row in an ascending order of the representative tone value. An encoded value EV correlated to the representative tone value that reaches or exceeds the tone value of the target pixel (representative tone value≧tone value of target pixel) for the first time in the sequential comparison is given as the encoded value EV converted from the tone value of the target pixel. For example, when the block number is ‘3’ and the tone value of the target pixel is ‘199’, the encoded value EV as the result of conversion is specified as ‘16’ according to the encoding table ET shown in FIG. 10. Namely the encoding table ET shows the range of the tone value in correlation to each encoded value EV by the parameter of the representative tone value.

FIG. 11 shows the data structure of the pre-decoding table DT1. As illustrated, the pre-decoding table DT1 records one of the index values used in the post-decoding table DT2 shown in FIG. 8 in correlation to each combination of the block number and the encoded value EV. In the decoding process, the decoding unit 420 (see FIG. 3) reads out an encoded value EV stored in the intermediate buffer BF and refers to the pre-decoding table DT1 to convert the encoded value EV into an index value. The index value varies in the range of ‘0’ to ‘164’. An index value ‘255’ set in the pre-decoding table DT1 of FIG. 11 represents dummy data, which is not referred to in the decoding process.

The decoding process is explained briefly. The decoding unit 420 refers to the pre-decoding table DT1 shown in FIG. 11 to convert a given encoded value EV to a correlated index value and subsequently refers to the post-decoding table DT2 shown in FIG. 8 to specify dot number data in correlation to the converted index value. The dot array data shown in FIG. 4 is then generated according to the dot number data and the ordinal number table ST shown in FIG. 7. In this manner, the decoding unit 420 generates the dot array data from the encoded value EV. The details of the decoding process will be described later.

The following describes the details of the table generation process at step S140 in the initialization process of FIG. 6 explained above.

### (C-1) Table Generation Process of Encoding Table and Pre-Decoding Table

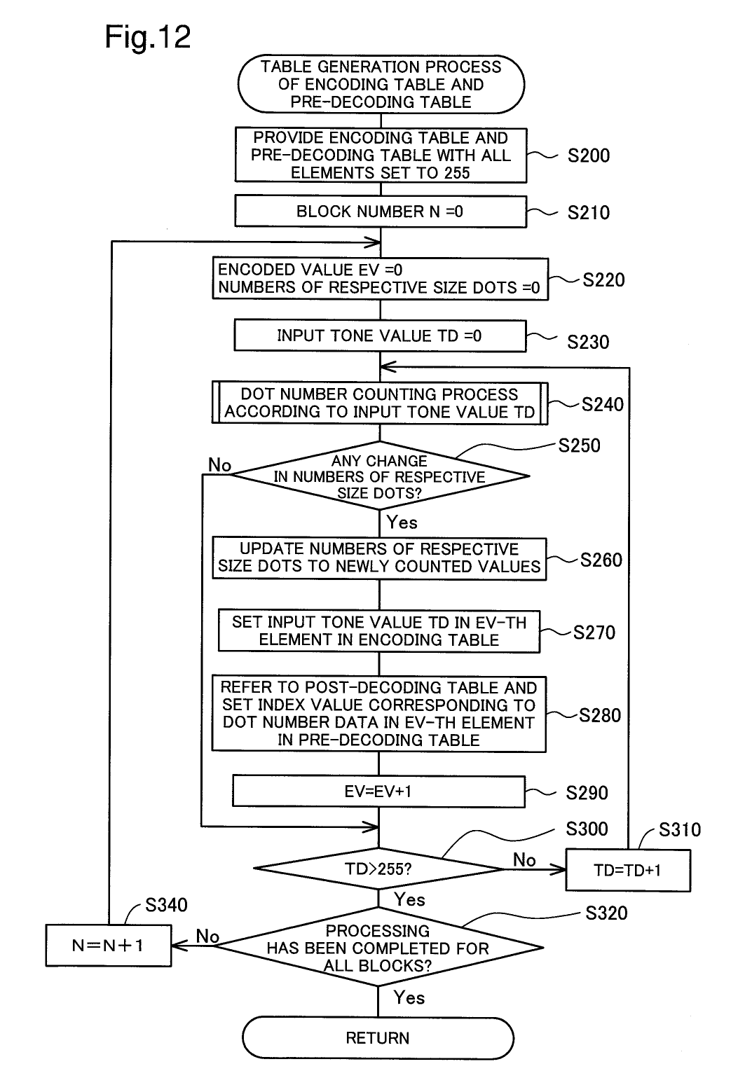

FIG. 12 is a flowchart showing the details of the table generation process (of the encoding table ET and the pre-decoding table DT1) executed at step S140 in the initialization process of FIG. 6. In the table generation process, the CPU 151 first provides an encoding table ET and a pre-decoding table DT1 with all the elements set to a value of ‘255’ (step S200).

After provision of the encoding table ET and the pre-decoding table DT1 with all the elements set to ‘255’, the CPU 151 sets a value ‘0’ to a current block number N representing a target block as a current object of processing (step S210), sets the value ‘0’ to an encoded value EV as a variable used in the subsequent processing and to all the numbers of the respective size dots (the S dot, the M dot, and the L dot) to be created in a target block as a current object (step S220), and also sets the value ‘0’ to a current input tone value TD (step S230).

The CPU 151 then performs a dot number counting process to determine the numbers of the respective size dots to be created in the target block according to the input tone value TD set at step S230 (step S240).

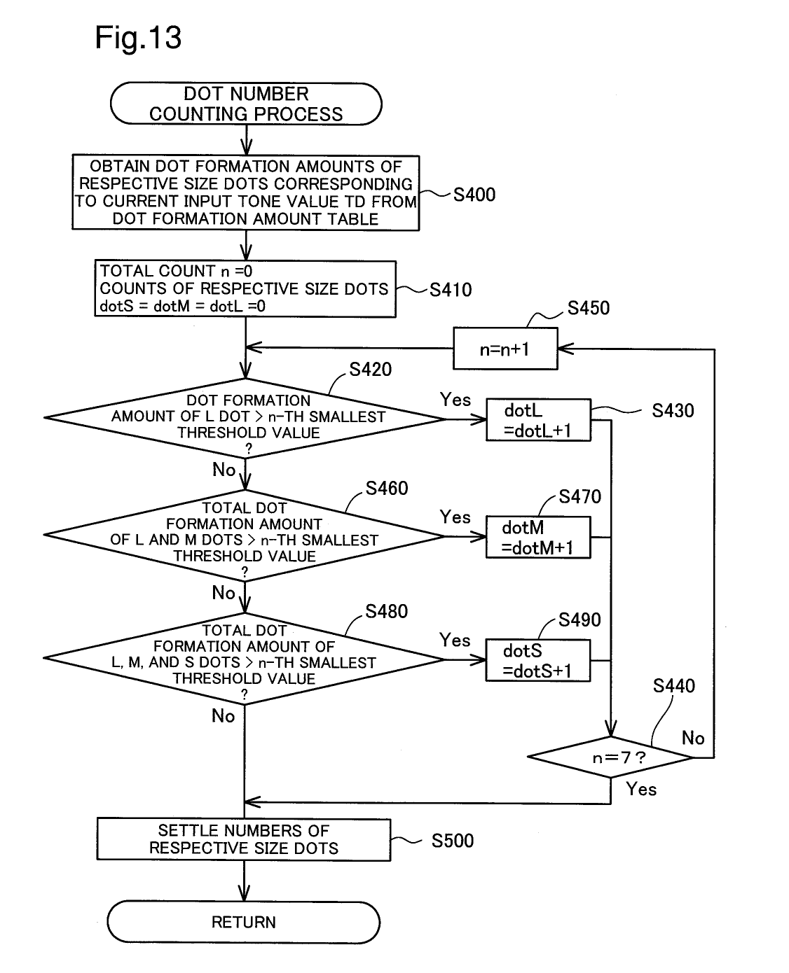

FIG. 13 is a flowchart showing the details of the dot number counting process executed at step S240 in the table generation process of FIG. 12. In the dot number counting process, the CPU 151 first refers to the dot formation amount table DGT (see FIG. 9) to obtain the dot formation amounts of the respective size dots corresponding to the input tone value TD set at step S230 (step S400).

After acquisition of the dot formation amounts of the respective size dots, the CPU 151 extracts a specific threshold value group corresponding to the current block number N from the dither matrix data DM (see FIG. 7) and sets the value ‘0’ to counts dotL, dotM, and dotS of the respective size dots and to a total count ‘n’ of all the size dots (step S410).

After setting the counts of the respective size dots and the total count ‘n’, the CPU 151 reads an n-th smallest threshold value corresponding to the current total count ‘n’ from the extracted specific threshold value group and determines whether the dot formation amount of the L dot obtained at step S400 is greater than the n-th smallest threshold value (step S420) When the dot formation amount of the L dot is greater than the n-th smallest threshold value (step S420: yes), the count dotL of the L dot is incremented by one (step S430). The number of the L dot to be arranged in the dot array data of 4×2 is accordingly increased by one.

After increment of the count dotL of the L dot, the CPU 151 determines whether the current total count ‘n’ is equal to ‘7’ (step S440). The total counter ‘n’=7 means that all the threshold values in the extracted specific threshold value group have already been referred to and that counting of the dot number is completed. The processing flow then goes to step S500 (described later). When the total count ‘n’ is not equal to ‘7’ at step S440, however, the CPU 151 increments the total count ‘n’ by one (step S450) and goes back the processing to step S420 to compare a next smallest threshold value with the dot formation amount.

When the dot formation amount of the L dot is not greater than the n-th smallest threshold value (step S420: no), on the other hand, the CPU 151 subsequently determines whether the sum of the dot formation amounts of the M dot and the L dot obtained from the dot formation amount table DGT is greater than the n-th smallest threshold value (step S460). When the sum of the dot formation amounts of the M dot and the L dot is greater than the n-th smallest threshold value (step S460: yes), the count dotM of the M dot is incremented by one (step S470). The number of the M dot to be arranged in the dot array data of 4×2 is accordingly increased by one.

After increment of the count dotM of the M dot, the processing flow goes to step S440 described above. When the total count ‘n’ is not equal to ‘7’ at step S440, the CPU 151 increments the total count ‘n’ by one (step S450) and goes back the processing to step S420.

When the sum of the dot formation amounts of the M dot and the L dot is not greater than the n-th smallest threshold value (step S460: no), on the other hand, the CPU 151 subsequently determines whether the sum of the dot formation amounts of the S dot, the M dot, and the L dot obtained from the dot formation amount table DGT is greater than the n-th smallest threshold value (step S480). When the sum of the dot formation amounts of the S dot, the M dot, and the L dot is greater than the n-th smallest threshold value (step S480: yes), the count dots of the S dot is incremented by one (step S490). The number of the S dot to be arranged in the dot array data of 4×2 is accordingly increased by one.

After increment of the count dotS of the S dot, the processing flow goes to step S440 described above. When the total count ‘n’ is not equal to ‘7’ at step S440, the CPU 151 increments the total count ‘n’ by one (step S450) and goes back the processing to step S420.

When the sum of the dot formation amounts of the S dot, the M dot, and the L dot is not greater than the n-th smallest threshold value (step S480: no) or when the total count ‘n’ is equal to ‘7’ (step S440: yes) meaning that all the eight threshold values in the specific threshold value group have already been referred to, the CPU 151 settles the current counts as the numbers of the respective size dots (step S500).

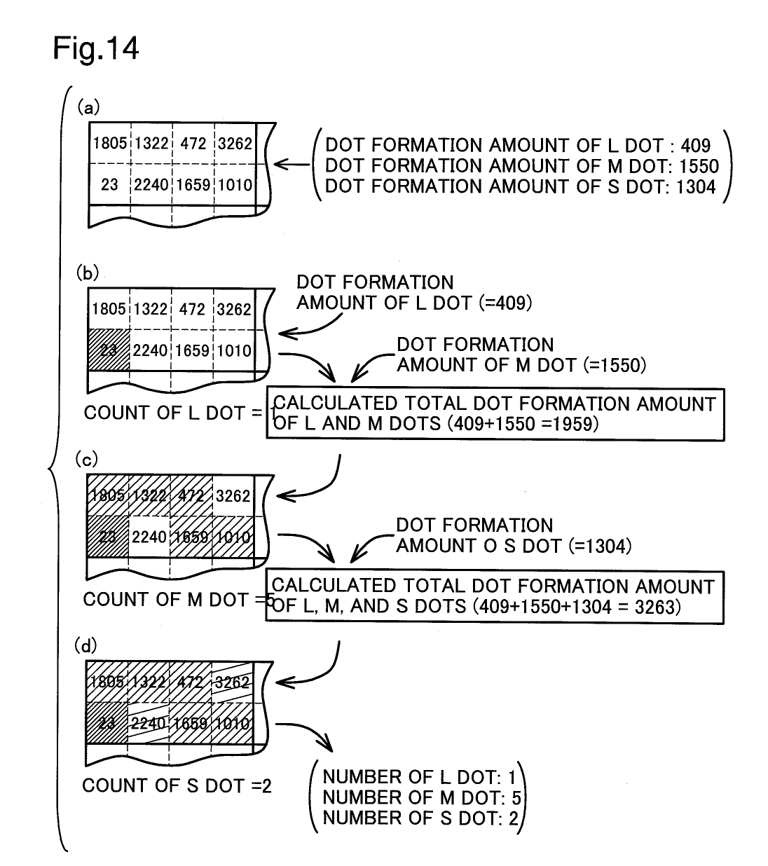

FIG. 14 shows a concrete example of the dot number counting process explained above. In this example, as shown in FIG. 14(a), the dot formation amount ‘409’ of the L dot, the dot formation amount ‘1550’ of the M dot, and the dot formation amount ‘1304’ of the S dot are obtained corresponding to the current input tone value TD from the dot formation amount table DGT. The specific threshold value group corresponding to the target block is the threshold value group shown in FIG. 7(b).

At step S420 in the dot number counting process of FIG. 13, a smallest threshold value ‘23’ in the threshold value group is compared with the dot formation amount ‘409’ of the L dot. Since the dot formation amount ‘409’ of the L dot is greater than the smallest threshold value ‘23’, an affirmative answer is given at step S420. In this case, the count of the L dot is incremented to ‘1’ at step S430 and the total count ‘n’ is incremented by one at step S450. At a next cycle of step S420, a second smallest threshold value ‘472’ in the threshold value group is compared with the dot formation amount ‘409’ of the L dot. Since the dot formation amount ‘409’ of the L dot is smaller than the second smallest threshold value ‘472’, the processing goes to step S460 in response to a negative answer at step S420. The count of the L dot is settled as ‘1’ as shown in FIG. 14(b).

At step S460, the total dot formation amount ‘1959’ (=409+1550) of the L dot and the M dot is compared with the second smallest threshold value ‘472’. Since the total dot formation amount ‘1959’ of the L dot and the M dot is greater than the second smallest threshold value ‘472’, an affirmative answer is given at step S460. In this case, the count of the M dot is incremented to ‘1’ at step S470 and the total count ‘n’ is incremented by one at step S450. The total dot formation amount ‘1959’ is still greater than a third smallest threshold value ‘1010’ in the threshold value group at step S460. The count of the M size is successively incremented at step S470 until a seventh smallest threshold value ‘2240’ in the threshold value group is referred to and compared with the total dot formation amount ‘1959’. The count of the M dot is eventually settled as ‘5’ as shown in FIG. 14(c).

Since the total dot formation amount ‘1959’ of the L dot and the M dot is smaller than the seventh smallest threshold value ‘2240’, the processing goes to step S480 in response to a negative answer at step S460. At step S480, the total dot formation amount ‘3263 (=409+1550+1304) of the L dot, the M dot, and the S dot is compared with the seventh smallest threshold value ‘2240’. Since the total dot formation amount ‘3263’ of the L dot, the M dot, and the S dot is greater than the seventh smallest threshold value ‘2240’, an affirmative answer is given at step S480. In this case, the count of the S dot is incremented to ‘1’ at step S490 and the total count ‘n’ is incremented by one at step S450 to refer to a largest (eighth smallest) threshold value ‘3262’ in the threshold value group.

Since the total dot formation amount ‘3263’ of the L dot, the M dot, and the S dot is still greater than the eighth smallest threshold value ‘3262’, an affirmative answer is again given at step S480. The count of the S dot is incremented again to ‘2’ at step S490. The count of the S dot is then settled as ‘2’ as shown in FIG. 14(d). Since the current total count ‘n’ is equal to ‘7’, an affirmative answer is given at step S440 to settle the counts of the respective size dots. In this concrete example, the settled counts are 1 L dot, 5 M dots, and 2 S dots.

As described above with reference to the concrete example of FIG. 14, the dot number counting process sequentially determines the number of the L dot, the number of the M dot, and the number of the S dot. The dot number counting process sequentially sums up the dot formation amounts of the respective size dots and makes comparison with the threshold values to determine the numbers of the respective size dots. The numbers of the respective size dots are eventually determined to enable sequential arrangement of the respective size dots in the descending order of the dot size in the target block without any overlap as shown in FIG. 14(d). The dot number counting process immediately terminates the processing when referring to a threshold value exceeding the total dot formation amount of all the size dots. It is thus not necessary to refer to all the threshold values unconditionally for all the blocks. This arrangement desirably accelerates the dot number counting process and thereby enables the high-speed initialization process.

Referring back to the flowchart of FIG. 12, after settlement of the numbers of the respective size dots at step S240 as the result of the dot number counting process of FIG. 13, the CPU 151 determines whether any of the numbers of the respective size dots corresponding to the current input tone value TD is changed from the numbers of the respective size dots corresponding to a previous input tone value TD (step S250). For example, when the result of a previous cycle of the dot number counting process is two S dots, five M dots, and one L dot and the result of a current cycle of the dot number counting process is two S dots, four M dots, and two L dots, the numbers of the M dot and the L dot are changed. In this case, a change is detected at step S250.

In the presence of any change (step S250: yes), the CPU 151 updates the numbers of the respective size dots corresponding to the current block number N and the encoded value EV to the newly counted values corresponding to the current input tone value TD at step S240 (step S260). The CPU 151 then sets the current input tone value TD as a representative tone value in an element defined by the current block number N and the encoded value EV in the encoding table ET provided at step S200 (step S270).

After setting the representative tone value in the encoding table ET, the CPU 151 refers to the post-decoding table DT2 (see FIG. 8) and specifies an index value correlated to dot number data representing the numbers of the respective size dots updated at step S260. For example, when the updated numbers of the respective size dots at step S260 are zero S dot, two M dots, and six L dots, an index value ‘160’ is obtained from the post-decoding table DT2 of FIG. 8. The CPU 151 sets the specified index value in an element defined by the current block number N and the encoded value EV in the pre-decoding table DT1 provided at step S200 (step S280).

On completion of the recording of the representative tone value in the encoding table ET and the recording of the index value in the pre-decoding table DT1, the CPU 151 increments the encoded value EV by one (step S290). The encoded value EV is successively incremented at step S290, in response to detection of any change in numbers of the respective size dots at step S250. Namely the encoded value EV is incremented in response to every change in dot arrangement of one block.

After incrementing the encoded value EV at step S290 or in the case of no change in numbers of the respective size dots (step S250: no), the CPU 151 determines whether the current input tone value TD exceeds the value of ‘255’ (step S300). When the current input tone value TD still does not exceed the value of ‘255’ (step S300:no), the CPU 151 increments the current input tone value TD by one (step S310) and goes back the processing to step S240. In this manner, the correlation of the input tone value TD to the encoded value EV is recorded in the encoding table ET with a variation of the input tone value TD from 0 to 255 with regard to the current target block. Simultaneously the correlation of the index value to the encoded value EV is recorded in the pre-decoding table DT1.

When the current input tone value TD exceeds the value of ‘255’ (step S300: yes), on the other hand, it is determined whether the above series of processing has been completed for all the blocks (step S320). In the case of the uncompleted processing (step S320: no), the CPU 151 increments the current block number N by one (step S340) and goes back the processing to step S220. Repetition of the above series of processing completes recording of the correlation of the input tone value TD to the encoded value EV in the encoding table ET and recording of the correlation of the index value to the encoded value EV in the pre-decoding table DT1 with regard to all the blocks. In the case of the completed processing for all the blocks (step S320: yes), the CPU 151 terminates the table generation process. The table generation process generates the encoding table ET shown in FIG. 10 and the pre-decoding table DT1 shown in FIG. 11 as described above.

The initialization process executed at step S10 in the printing process of FIG. 5 follows the series of processing explained above. The following describes the details of the halftoning process based on the various tables generated in this initialization process.

### (D) Halftoning Process

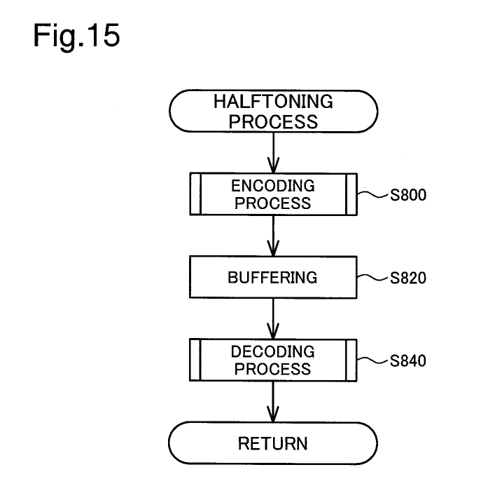

FIG. 15 is a flowchart showing the details of the halftoning process executed at step S40 in the printing process of FIG. 5. The halftoning process successively refers to the various table (the encoding table ET, the pre-decoding table DT1, the post-decoding table DT2, and the ordinal number table ST) generated in the initialization process described above to generate dot array data with regard to each pixel in a CMY image.

On the start of the halftoning process, the encoding unit 410 in the image processing ASIC 155 (see FIG. 3) is activated to perform the encoding process of converting the tone values of the respective colors (C, M, Y, K, Lc, and Lm) in a target pixel as a current object of processing into encoded values EV (step S800).

### (D-1) Encoding Process

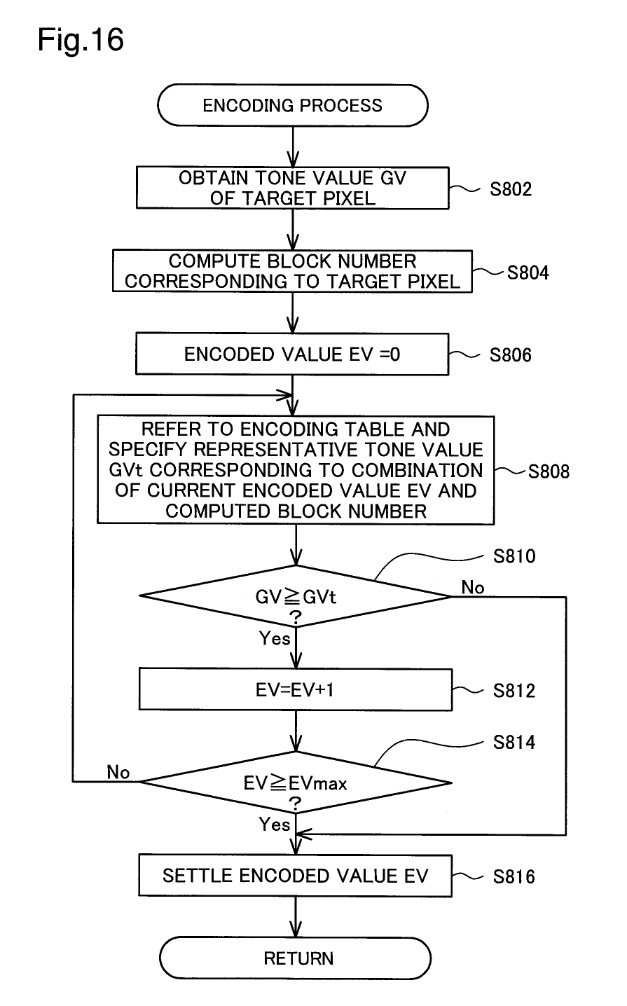

FIG. 16 is a flowchart showing the details of the encoding process executed at step S800 in the halftoning process of FIG. 15. This encoding process converts a tone value of each pixel into an encoded value EV.

On the start of the encoding process, the encoding unit 410 successively inputs a CMY image in the unit of one line from the color conversion unit 300 and successively obtains a tone value GV of each target pixel in an X direction (rightward) on the input line (step S802).

After acquisition of the tone value GV of the target pixel, the encoding unit 410 computes a block number corresponding to the target pixel (step S804). In this embodiment, one tone value GV is expressed by a dot group of 4×2 dots as shown in FIG. 4. The dot group of 4×2 dots corresponds to one block of 4×2 elements in the dither matrix DM shown in FIG. 7. When the position of the target pixel in the CMY image is identified, the position of the block in the dither matrix DM corresponding to the position of the target pixel is readily specifiable.

FIG. 17 is a conceptual view showing one method of computing the block number corresponding to the target pixel. The dither matrix DM shown in FIG. 7(a) has the total of 8192 blocks, 128 blocks in the lateral direction and 64 blocks in the vertical direction. The method divides input image data representing one input image into pixel units of 128 pixels×64 pixels and allocates block numbers 0 to 8191 to respective pixels included in each pixel unit of 128 pixels×64 pixels. The block number corresponding to the target pixel is computed on the assumption that the dither matrix DM is repeatedly applied in a uniform manner to these pixel units of the input image data as shown in FIG. 17.

Each target pixel successively set as a current object of the encoding process is defined by coordinates (X, Y). Block numbers of ‘0’ to ‘127’ are sequentially allocated to the target pixel having the Y coordinate fixed to ‘0’ and the X coordinate varying from ‘0’ to ‘127’. The block number of ‘0’ is reallocated to the target pixel having the Y coordinate unchanged at ‘0’ and the X coordinate of ‘128’. In this manner, the block numbers of ‘0’ to ‘127’ are repeatedly allocated with a shift of the target pixel in the X direction of the input image. A block number of ‘128’ is then allocated to the target pixel having the coordinates (0,1). At the Y coordinate fixed to ‘1’, block numbers of ‘128’ to ‘255’ are repeatedly allocated with a shift of the target pixel in the X direction of the input image. In general, a block number N is calculated from the coordinates (X,Y) of the target pixel as the current object of the encoding process according to Equation (2) given below:

N=(X %128)+(Y %64)*128 (2)

In Equation (2), ‘%’ denotes an operator of calculating a residue.

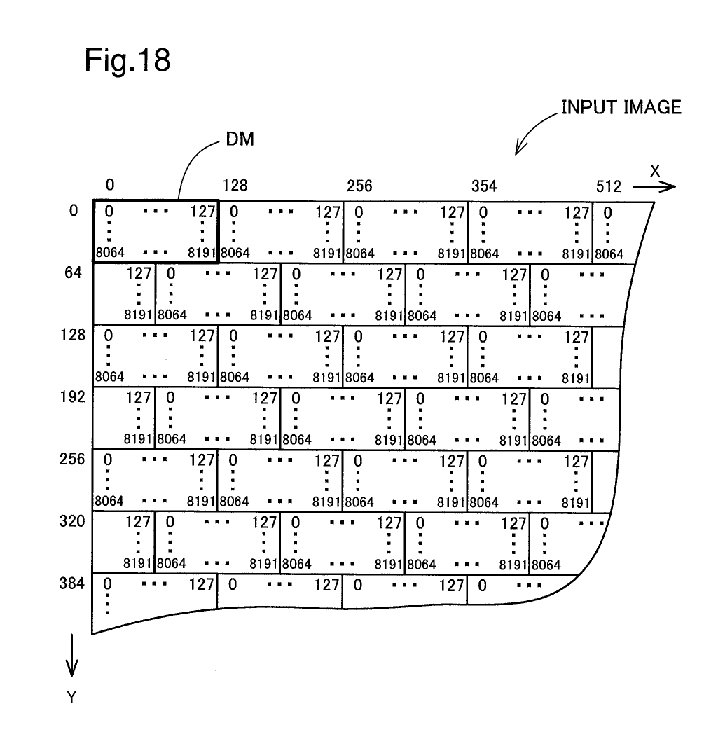

FIG. 18 is a conceptual view showing another method of computing the block number corresponding to the target pixel. The method of FIG. 17 computes the block number corresponding to the target pixel on the assumption that the dither matrix DM is repeatedly applied in the uniform manner to the respective pixel units of the input image data. The method of FIG. 18, on the other hand, displaces the dither matrix DM repeatedly applied to each even number line by 64 pixels in the X direction from the dither matrix DM repeatedly applied to each odd number line. This alternate displacement of the dither matrix DM in the input image effectively prevents the repeated pattern of the dither matrix DM from affecting an output image, thus improving the picture quality of the output image.

As mentioned above, the encoding unit 410 successively inputs the CMY image in the unit of one line. For example, the block numbers of ‘0’ to ‘127’ are repeatedly applied to a first line of the input CMY image by referring to either FIG. 17 or FIG. 18. In the encoding process of the embodiment, the encoding unit 410 registers in advance only a required part of the encoding table ET corresponding to the Y coordinate of each input line into the SRAM 156. The encoding unit 410 is thus not required to read the encoding table ET stored in the RAM 152 having the lower access speed than that of the SRAM 156 for acquisition of the tone value GV of each target pixel on the input line. This arrangement desirably enhances the processing speed.

Referring back to the flowchart of FIG. 16, after computation of the block number corresponding to the target pixel at step S804, the encoding unit 410 initializes the encoded value EV to ‘0’ (step S806). The encoding unit 410 then refers to the encoding table ET shown in FIG. 10 (more precisely, the required part of the encoding table ET registered in the SRAM 156) and specifies a representative tone value GVt corresponding to the combination of the block number computed at step S804 and the current encoded value EV (step S808).

The encoding unit 410 compares the specified representative tone value GTv with the tone value GV of the target pixel obtained at step S802 and determines whether the tone value GV of the target pixel is not less than the representative tone value GVt (step S810). When the tone value GV is not less than the representative tone value GVt (step S810: yes), the encoding unit 410 increments the current encoded value EV by one (step S812) and determines whether the incremented encoded value EV reaches or exceeds a preset maximum value EVmax (step S814). When the encoded value EV reaches or exceeds the maximum value EVmax (step S814: yes), the maximum value EVmax is settled as the encoded value EV (step S816).

When the encoded value EV is less than the maximum value EVmax (step S814: no), on the other hand, the encoding unit 410 goes back the processing to step S808 and subsequent steps to specify a representative tone value GVt corresponding to the incremented encoded value EV and compare the tone value GV of the target pixel with the newly specified representative tone value GVt. In the course of repetition of this series of processing, when it is determined for the first time that the tone value GV is less than the representative tone value GVt (step S810: no), the encoded value EV at the moment is settled as the encoded value EV (step S816).

The encoding process refers to the encoding table ET shown in FIG. 10 to convert the tone value of each input pixel into a 5-bit encoded value according to the position of the block corresponding to the input pixel. The encoding unit 410 performs this encoding process with regard to all the pixels constituting the CMY image.

Referring back to the flowchart of FIG. 15, the encoding unit 410 buffers the encoded value EV, which is converted from the tone value of the target pixel by the encoding process described above, in the intermediate buffer BF set in the RAM 152 (step S820). As the result of the encoding process, the 5-bit encoded value EV, instead of the 8-bit tone value, is registered in the intermediate buffer BF. This significantly saves the storage space of the RAM 152.

After the encoding unit 410 buffers the encoded value EV in the intermediate buffer BF at step S820, the decoding unit 420 performs the decoding process to generate dot array data shown in FIG. 4, based on the buffered encoded value EV (step S840). The decoding unit 420 starts the decoding process in response to buffering of even one encoded value EV without waiting for buffering of encoded values EV for all the pixels constituting the image data. Namely the decoding process is performed substantially simultaneously in parallel to the encoding process.

### (D-2) Decoding Process

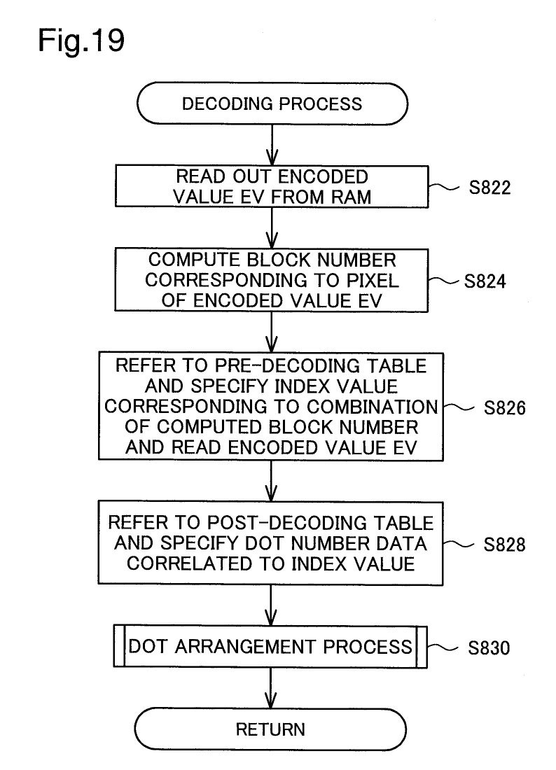

FIG. 19 is a flowchart showing the details of the decoding process executed at step S840 in the halftoning process of FIG. 15. On the start of the decoding process, the decoding unit 420 reads out the encoded values EV stored in the intermediate buffer BF (step S822). The decoding process reads out the encoded values EV corresponding to one line of the input image data from the intermediate buffer BF in the unit of one line.

The decoding unit 420 computes a block number corresponding to a specific pixel as the generation source of each target encoded value EV as a current object of the decoding process (step S824). The encoded values EV are buffered in the intermediate buffer BF in the order of the encoding process. The encoded values EV are read from the intermediate buffer BF in this buffering order, so that the block number corresponding to each target encoded value EV is thus readily computable according to the computation method described above. In the decoding process of the embodiment, the decoding unit 420 registers in advance only required parts of the pre-decoding table DT1 and the ordinal number table ST corresponding to the block number into the SRAM 156.

After computation of the block number, the decoding unit 420 refers to the pre-decoding table DT1 shown in FIG. 11 (more precisely, the required part of the pre-decoding table DT1 registered in the SRAM 156) and specifies an index value corresponding to the combination of the encoded value EV read out at step S822 and the block number computed at step S824 (step S826). The decoding unit 420 subsequently refers to the post-decoding table DT2 and specifies dot number data correlated to the specified index value (step S828). The whole post-decoding table DT2 is registered in advance in the SRAM 156, since the post-decoding table DT2 requires only a relatively small memory capacity (165×16 bits=330 bytes) and does not significantly consume the storage space of the SRAM 156. After specification of the dot number data in the post-decoding table DT2, the decoding unit 420 performs a dot arrangement process to arrange the respective size dots in each block and thereby generate dot array data (step S830).

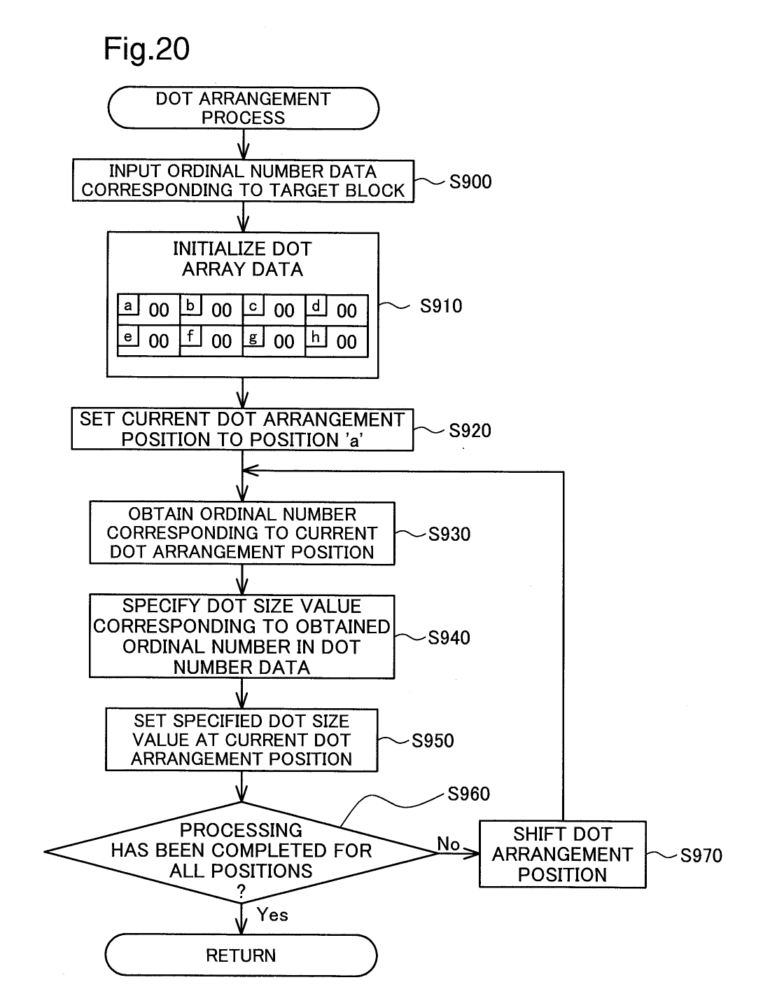

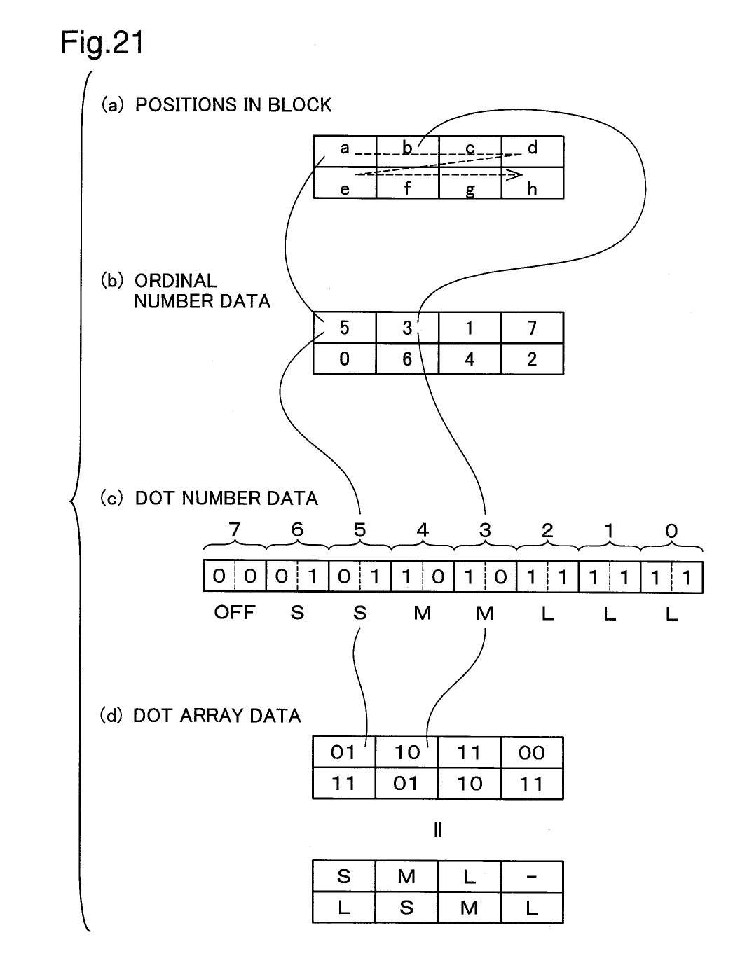

FIG. 20 is a flowchart showing the details of the dot arrangement process executed at step S830 in the decoding process of FIG. 19. FIG. 21 shows a concrete example of the dot arrangement process. On the start of the dot arrangement process of FIG. 20, the decoding unit 420 refers to the required part of the ordinal number table ST (see FIG. 7(d)) registered in the SRAM 156 and inputs ordinal number data (see FIG. 7(c)) corresponding to each target block as a current object of dot arrangement (step S900). The decoding unit 420 initializes dot array data by setting the dot size value ‘00’ representing ‘non-dot’ to all the elements included in the target block (step S910) and sets a current dot arrangement position to a position ‘a’ (an uppermost left position) in the target block shown in FIG. 21(a) (step S920).

After setting the current dot arrangement position in the target block, the decoding unit 420 obtains an ordinal number corresponding to the current dot arrangement position from the ordinal number data (step S930). FIG. 21(b) shows one example of the ordinal number data input from the ordinal number table ST. In this illustrated example, an ordinal number ‘5’ is set at the current dot arrangement position ‘a’, so that the ordinal number ‘5’ is obtained at step S930.

The decoding unit 420 then specifies a dot size value corresponding to the ordinal number obtained at step S930 according to the dot number data obtained from the post-decoding table DT2 (step S940). A concrete procedure counts up the 2-bit position from the lowest two bits of the dot number data by the ordinal number obtained at step S930 and specifies a dot size value recorded at the counted-up 2-bit position. FIG. 21(c) shows one example of the dot number data obtained from the post-decoding table T2. In this illustrated example, the dot size value corresponding to the ordinal number ‘5’ is a dot size value ‘01’ recorded at a 6^{th} 2-bit position from the lowest two bits of the dot number data. The dot size value ‘01’ represents the S dot.

The decoding unit 420 sets the specified dot size value at the current dot arrangement position in the target block (step S950). When the current dot arrangement position is the position ‘a’, the dot size value ‘01’ specified in the dot number data of FIG. 21(c) is set at the current dot arrangement position ‘a’ as shown in FIG. 21(d).

After setting the specified dot size value at the current dot arrangement position, the decoding unit 420 determines whether the setting of the dot size value has been completed for all the positions in the target block (step S960). On completion of the setting of the dot size values at all the positions in the target block (step S960: yes), the decoding unit 420 terminates the dot arrangement process. In the case of in completion of the setting of the dot size values at all the positions in the target block (step S960: no), on the other hand, the decoding unit 420 shifts the dot arrangement position in the order of a, b, c, d, . . . h in the target block (see FIG. 21(a)) (step S970) and goes back the processing to step S930 and subsequent steps to set dot size values at all the positions in the target block.

On completion of the dot arrangement process with regard to all the encoded values EV buffered in the intermediate buffer BF, the decoding unit 420 terminates the decoding process of FIG. 19. The dot array data generated by the decoding process is output to the ink ejection control unit 500, which controls the ink heads 211 to form dots according to this dot array data. The procedure of this embodiment arranges the respective size dots in each block and generates the dot array data by referring to the ordinal number table. One modified procedure may directly refer to each block in the dither matrix data DM and sequentially specify elements in the block in an ascending order of the threshold value as dot arrangement positions to generate dot array data.

The halftoning process of the embodiment has the following advantage. According to comparison between the dot array data shown in FIG. 21(d) and the ordinal number data of 4×2 elements shown in FIG. 21(b), dots are sequentially arranged without any overlap in such a manner that the larger size dot is arranged at the position of the lower ordinal number. The lower ordinal number represents the smaller threshold value (see FIG. 7(b)). The dither matrix data DM shown in FIG. 7(a) has the characteristic of the dither pattern adopted in the systematic dither method and arranges the smaller threshold values with the higher dispersibility and the larger threshold values to avoid the positions of the threshold values arranged previously. In the dot array data of FIG. 21(d), the larger size dot is preferentially arranged at the position of the lower ordinal number or the smaller threshold value. The larger size dot accordingly has the higher dispersibility. The dot arrangement method of the embodiment ensures the highest dispersibility for the largest size dot, which is prominent in an output image printed on the printing paper P, thus significantly improving the picture quality of the output image.

The dither matrix data DM used in the embodiment may be a dither matrix with the blue noise characteristic of ensuring the good dot dispersion. The blue noise dither matrix has no specific regularity in setting of tone values in respective blocks and allows different ranges of encoded values to be set in the respective blocks. The conventional density pattern method uniformly converts the respective tone values to multiple values and may reduce the effective number of tones. The procedure of this embodiment, however, performs the halftoning process in the unit of one block of 4×2 dots, while varying the dot formation pattern according to the position of each block in the dither matrix. This arrangement significantly improves the picture quality of the output image, compared with the conventional halftoning technique.

The procedure of the embodiment generates the various tables used in the halftoning process, based on the dither matrix data DM and the dot formation amount table DGT. The picture quality of the output image is thus relatively easily improved by optimizing the arrangement of threshold values in the dither matrix DM. The embodiment adopts the data structure of the tables to perform the halftoning process according to the position of each block. This data structure enables the more flexible improvement of the picture quality, compared with uniform conversion tables adopted in the conventional halftoning technique.

The halftoning process of the embodiment successively refers to the encoding table ET, the pre-decoding table DT1, the post-decoding table DT2, and the ordinal number table ST to complete halftoning of input CMY image data. This arrangement enables the extremely high-speed halftoning process without requiring any complicated operations like error dispersion as in the conventional halftoning techniques like the error diffusion method.

The halftoning process of the embodiment is parted into the two stages, the encoding process and the decoding process, and temporarily stores the encoded values EV obtained by the encoding process into the intermediate buffer BF set in the RAM 152. Even when some time is required for actual dot formation by the printing mechanism, the encoding process can be completed quickly by buffering the encoded value EV obtained by the encoding process into the RAM 152. This arrangement enables the CPU 151 to be promptly freed from the printing-related processing. The intermediate buffer BF stores 5-bit encoded values EV converted from 8-bit CMY image data (256 tones) with regard to the respective colors. This significantly saves the storage space of the RAM 152 and thereby reduces the cost.

In the embodiment, the initialization process is performed in every cycle of the printing process as described above with reference to the flowchart of FIG. 5. This is, however, not restrictive, but the initialization process may be performed at any other suitable timings, for example, at the time of power supply of the printer 100 or in response to every change of the user's settings of a printing paper and a print mode.

### (E) Another Method of Encoding Process

The encoding process may be performed according to another method as described below. The encoding process shown in FIG. 16 sequentially increments the encoded value EV and, when a representative tone value GVt corresponding to a certain encoded value EV reaches or exceeds the current tone value GV for the first time, outputs the certain encoded value EV as the settled encoded value EV. This process is equivalent to a process of sequentially comparing representative tone values arranged in an ascending order in the encoding table ET with each target tone value, searching for an ordinal number corresponding to a minimum representative tone value selected among representative tone values equal to or greater than the target tone value, and outputting the searched ordinal number as an encoded value. This encoding process may be efficiently actualized by a simple circuit structure adopting the binary search technique.

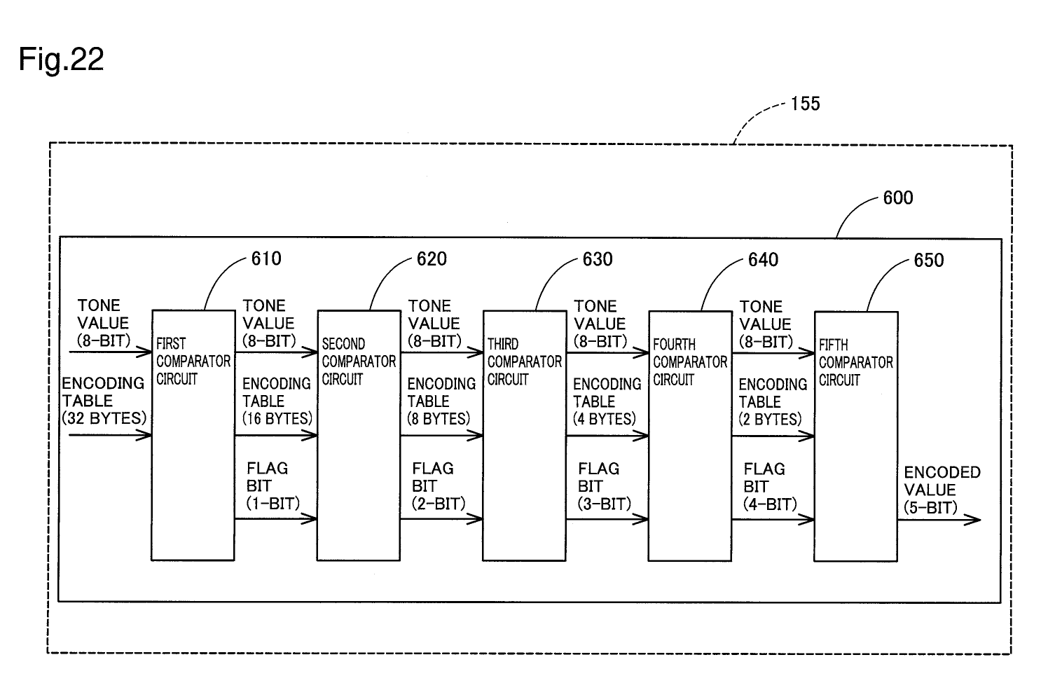

FIG. 22 shows the schematic structure of an encoded value search unit 600 provided in the image processing ASIC 155. The encoded value search unit 600 has the similar functions to those of the encoding unit 410 shown in FIG. 3. The encoded value search unit 600 includes a first comparator circuit 610, a second comparator circuit 620, a third comparator circuit 630, a fourth comparator circuit 640, and a fifth comparator circuit 650. These comparator circuits are connected in series as illustrated.

The first comparator circuit 610 inputs an 8-bit CMY tone value in the range of ‘0’ to ‘255’ from the color conversion unit 300, while inputting thirty-two representative tone values (hereafter referred to as ‘table data’) corresponding to a current block number, which is computed by the block number computation method explained previously, in an ascending order from the encoding table ET. Each table data is 8-bit data representing one of the values in the range of ‘0’ to ‘255’. The first comparator circuit 610 accordingly inputs a total of 32-byte table data from the encoding table ET.

The first comparator circuit 610 compares a medium value of the thirty-two table data input from the encoding table ET with the CMY tone value input from the color conversion unit 300. When the CMY tone value is greater than the medium value of the thirty-two table data (more precisely, a 16^{th} smallest value), sixteen table data of greater than the medium value are selected. In this state, the first comparator circuit 610 sets a value ‘1’ to a resulting bit representing the result of the comparison. When the CMY tone value is not greater than the medium value of the thirty-two table data, on the other hand, sixteen table data of not greater than the medium value are selected. In this state, the first comparator circuit 610 sets a value ‘0’ to the resulting bit. The first comparator circuit 610 transfers the selected sixteen table data, the resulting bit, and the CMY tone value to the second comparator circuit 620 located after the first comparator circuit 610.

The second comparator circuit 620 inputs the sixteen table data, the resulting bit, and the CMY tone value from the first comparator circuit 610, compares a medium value of the input sixteen table data with the CMY tone value in the similar manner as in the first comparator circuit 610, and transfers selected eight table data, 2-bit resulting bit data, and the CMY tone value to the third comparator circuit 630. The third comparator circuit 630, the fourth comparator circuit 640, and the fifth comparator circuit 650 successively performs the similar processing. The fifth comparator circuit 650 eventually outputs 5-bit resulting bit data. A 5-bit encoded value expressed by the output 5-bit resulting bit data is given as a result of the encoding process. The detailed structures of the respective comparator circuits 610 to 650 and a concrete example of determining an encoded value are described below.

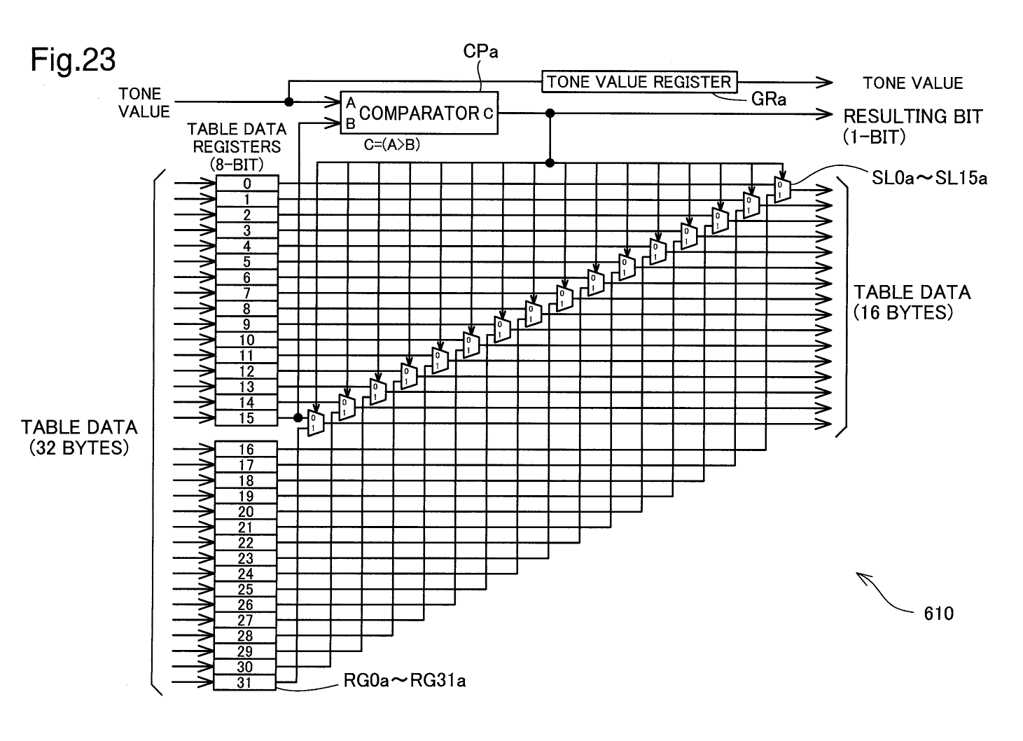

FIG. 23 is a circuit block diagram of the first comparator circuit 610. As illustrated, the first comparator circuit 610 includes thirty-two table data registers RG0a to RG31a, sixteen selectors SL0a to SL15a, a comparator CPa, and a tone value register GRa for input of a CMY tone value.

The tone value register GRa stores the CMY tone value input from the color conversion unit 300 and directly transfers the stored CMY tone value to the second comparator circuit 620.

The table data registers RG0a to RG31a input the thirty-two table data corresponding to the current block in an ascending order from the encoding table ET via the SRAM 156.

Each of the selectors SL0a to SL15a is connected to two table data registers. For example, the table data registers RG0a and RG16a are connected with the selector SL0a, whereas the table data registers RG1a and RG17a are connected with the selector SL1a. In general, a selector SL(x) a (where x is a selector number varying from ‘0’ to ‘15’) is connected to a table data register RG(x)a and a table data register RG(x+16)a. An output of the comparator CPa enters as a select signal into each of the selectors SL0a to SL15a. When the input select signal represents a value ‘0’, each selector selects a table data register having the smaller register number out of the two table data registers connected thereto and outputs table data stored in the selected register to the second comparator circuit 620. When the input select signal represents a value ‘1’, on the other hand, each selector selects a table data register having the larger register number out of the two table data registers connected thereto and outputs table data stored in the selected register to the second comparator circuit 620. In this manner, the respective selectors SL0a to SL15a select either the table data recorded in the table data registers RG0a to RG15a or the table data recorded in the table data registers RG16a to RG31a in response to the select signal output from the comparator CPa and output the selected sixteen table data to the second comparator circuit 620.

The comparator CPa has two input terminals A and B and one output terminal C. The input terminal A is connected with the color conversion unit 300 and receives the input of the CMY tone value. The input terminal B receives the input of table data stored in the table data register RG15a as the medium value of the thirty-two table data. The comparator CPa compares the input values of the two input terminals A and B and outputs a value ‘1’ to the output terminal C in response to a comparison result of ‘A>B’ and a value ‘0’ to the output terminal C in response to a comparison result of ‘A≦B’. By the combined functions of the comparator CPa with the sixteen selectors SL0a to SL15a, when the CMY tone value is greater than the medium value of the thirty-two table data, sixteen table data of greater than the medium value are output to the second comparator circuit 620. When the CMY tone value is not greater than the medium value of the thirty-two table data, on the other hand, sixteen table data of not greater than the medium value are output to the second comparator circuit 620. The output value of the output terminal C is input into the sixteen selectors SL0a to SL15a and to the second comparator circuit 620 as a resulting bit representing the comparison result of the comparator CPa.

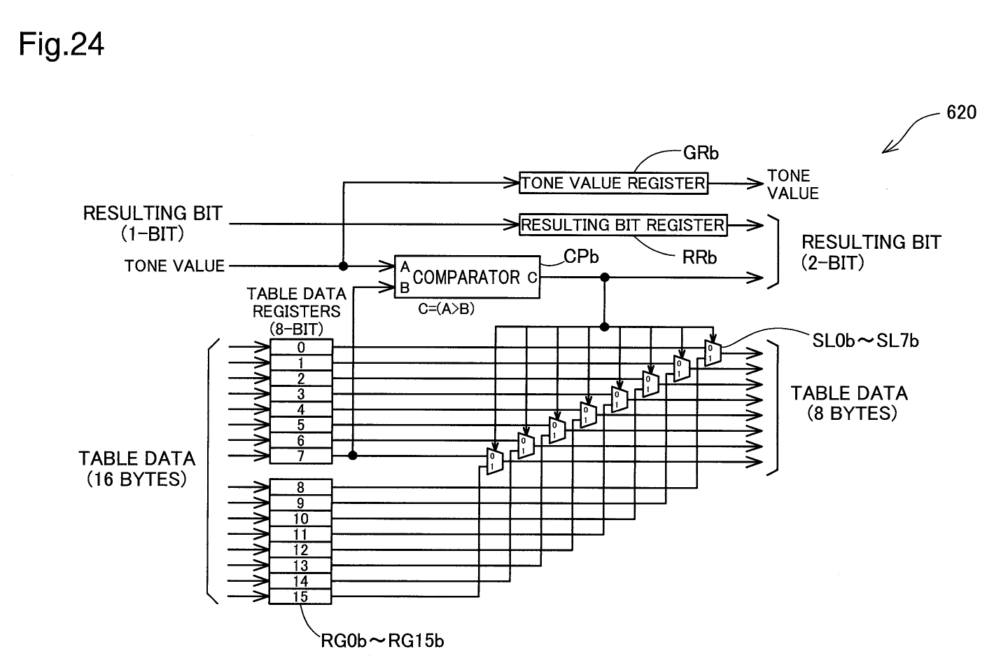

FIG. 24 is a circuit block diagram of the second comparator circuit 620. As illustrated, the second comparator circuit 620 includes sixteen table data registers RG0b to RG15b, eight selectors SL0b to SL7b, a comparator CPb, a tone value register GRb for input of the CMY tone value, and a resulting bit register RRb.

The sixteen table data transferred from the first comparator circuit 610 are input in an ascending order into the table data registers RG0b to RG15b. The comparator CPb compares the CMY tone value input from the tone value register GRa of the first comparator circuit 610 with a medium value of the sixteen table data stored in the table data register RG7b and outputs a comparison result as a select signal to the respective selectors SL0b to SL7b. When the CMY tone value is greater than the medium value of the sixteen table data, eight table data of greater than the medium value stored in the table data registers RG8b to RG15b are output by the selectors SL0b to SL7b to the third comparator circuit 630. When the CMY tone value is not greater than the medium value of the sixteen table data, on the other hand, eight table data of not greater than the medium value stored in the table data registers RG0b to RG7b are output by the selectors SL0b to SL7b to the third comparator circuit 630.

The resulting bit register RRb stores the resulting bit input from the comparator CPa of the first comparator circuit 610. The resulting bit stored in the resulting bit register RRb is combined with a resulting bit representing the comparison result of the comparator CPb in the second comparator circuit 620 and is output as 2-bit resulting bit data to the third comparator circuit 630.

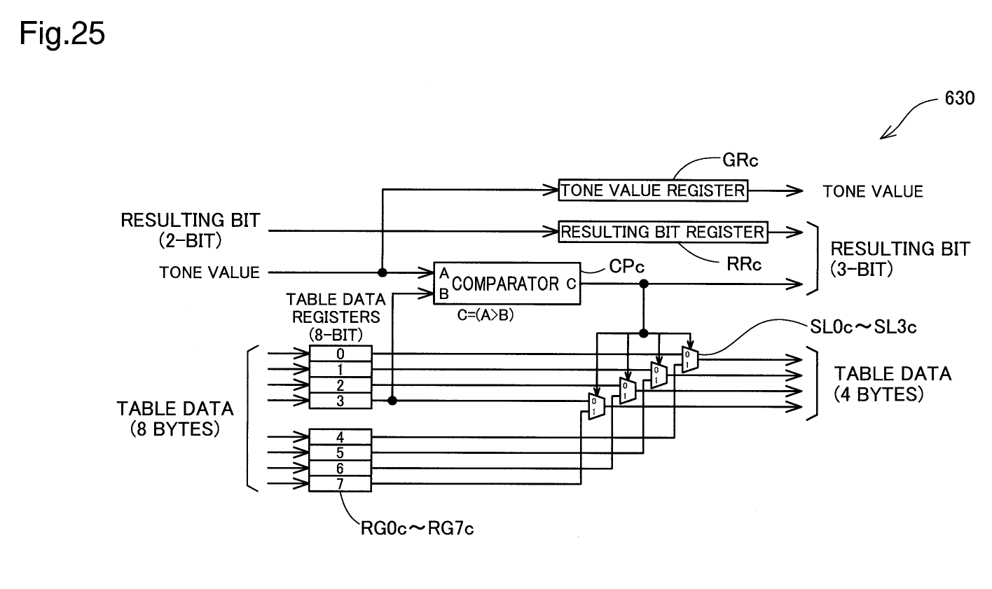

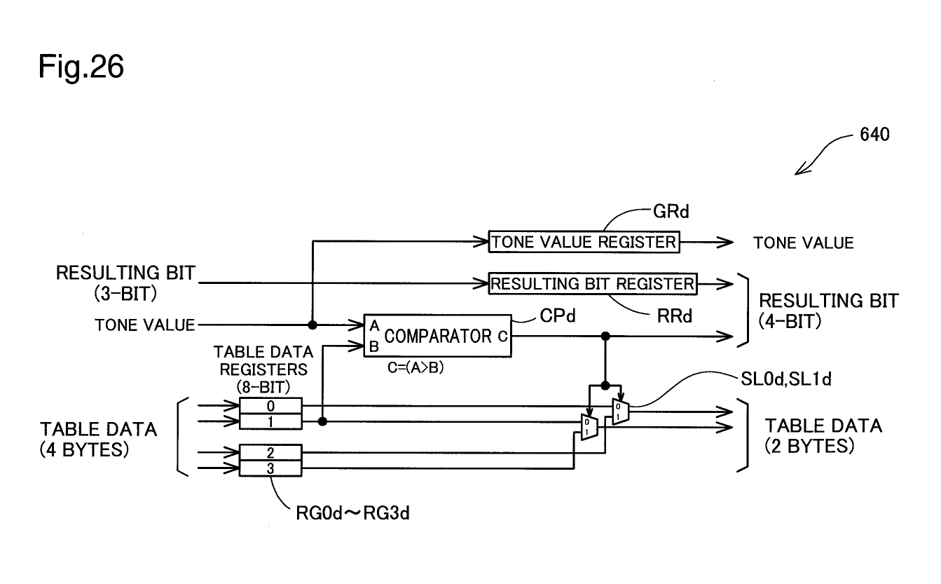

FIG. 25 is a circuit block diagram of the third comparator circuit 630, and FIG. 26 is a circuit block diagram of the fourth comparator circuit 640. The third and the fourth comparator circuits 630 and 640 have similar circuit structures to that of the second comparator circuit 620 shown in FIG. 24 with difference in numbers of table data registers and selectors. The third comparator circuit 630 shown in FIG. 25 inputs the eight table data, the 2-bit resulting bit data, and the CMY tone value from the second comparator circuit 620 and performs the similar operations to those of the first comparator circuit 610 and the second comparator circuit 620 to output four table data, 3-bit resulting bit data, and the CMY tone value to the fourth comparator circuit 640. The fourth comparator circuit 640 shown in FIG. 26 inputs these data and performs the similar operations to those of the preceding comparator circuits 610 to 630 to output two table data, 4-bit resulting bit data, and the CMY tone value to the fifth comparator circuit 650.

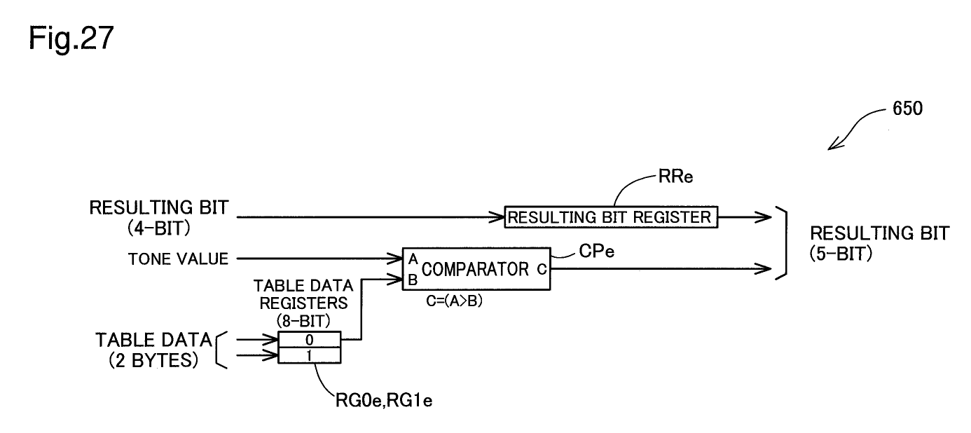

FIG. 27 is a circuit block diagram of the fifth comparator circuit 650. The fifth comparator circuit 650 includes two table data registers RG0e and RG1e, a comparator CPe, and a resulting bit register RRe. The two table data output from the fourth comparator circuit 640 are input in an ascending order to the table data register RG0e and RG1e. The comparator CPe receives the input of table data stored in the table data register RG0e as a medium value of the two table data and the input of the CMY tone value, compares these two inputs, and outputs a comparison result as a resulting bit. The resulting bit register RRe stores the 4-bit resulting bit data output from the fourth comparator circuit 640. 5-bit resulting bit data including the stored 4-bit resulting bit data and the 1-bit resulting bit data output from the comparator CPe is eventually output as a 5-bit encoded value from the encoded value search unit 600. The encoded value output from the encoded value search unit 600 is stored in the intermediate buffer BF. The table data register RG1e may be omitted from the circuit structure of the fifth comparator circuit 650. This is because the table data input into the comparator CPe is always the table data stored in the table data register RG0e.

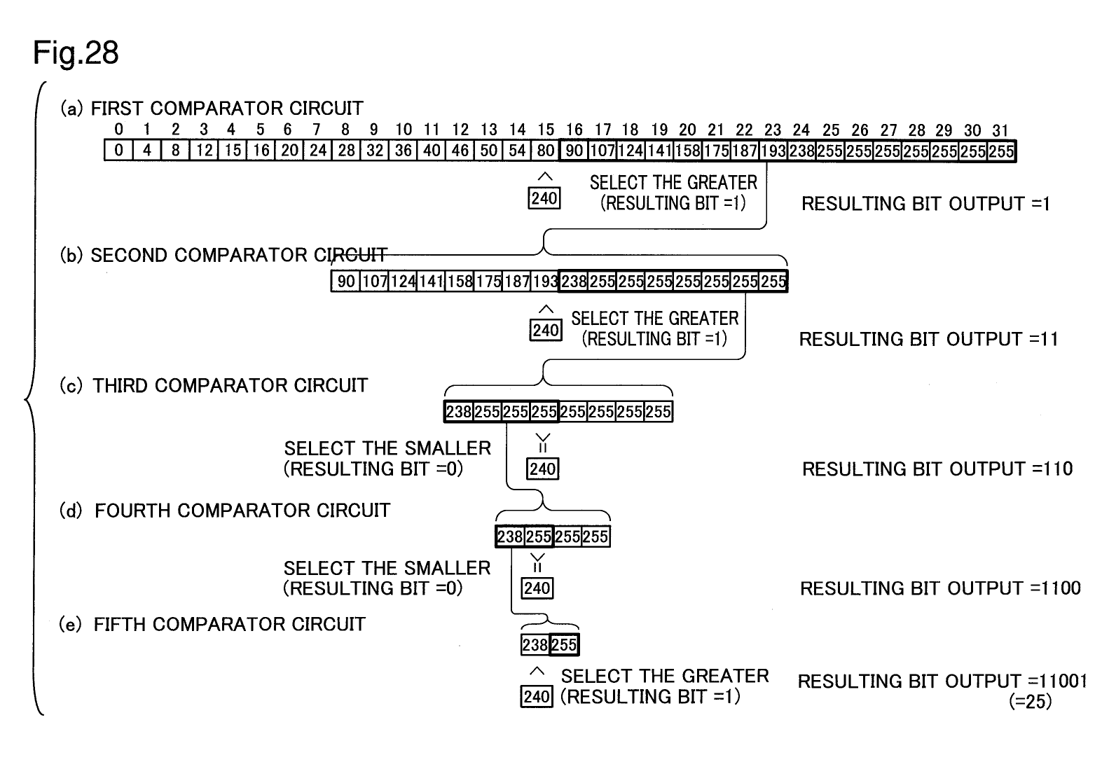

FIG. 28 shows a concrete example of determining an encoded value by the encoded value search unit 600. FIG. 28(a) shows an example of thirty-two table data input into the first comparator circuit 610 and the result of comparison between these thirty-two table data and an input CMY tone value ‘240’. The first comparator circuit 610 having the circuit structure of FIG. 23 compares the input CMY tone value ‘240’ with a medium value ‘80’ of these thirty-two table data. Since the CMY tone value is greater than the medium value, the first comparator circuit 610 selects sixteen table data of greater than the medium value among the thirty-two table data and transfers the selected sixteen table data to the second comparator circuit 620. The first comparator circuit 610 also outputs a resulting bit ‘1’ as the comparison result.

FIG. 28(b) shows the result of comparison between the sixteen table data input into the second comparator circuit 620 and the CMY tone value ‘240’. The second comparator circuit 620 having the circuit structure of FIG. 24 compares the CMY tone value ‘240’ with a medium value ‘193’ of the sixteen table data output from the first comparator circuit 610. Since the CMY tone value is greater than the medium value, the second comparator circuit 620 selects eight table data of greater than the medium value among the sixteen table data and transfers the selected eight table data to the third comparator circuit 630. The second comparator circuit 620 also outputs a resulting bit ‘1’ as the comparison result and adds this resulting bit to the end of the resulting bit output from the first comparator circuit 610. The second comparator circuit 620 accordingly outputs 2-bit resulting bit data ‘11’.

FIG. 28(c) shows the result of comparison between the eight table data input into the third comparator circuit 630 and the CMY tone value ‘240’. The third comparator circuit 630 having the circuit structure of FIG. 25 compares the CMY tone value ‘240’ with a medium value ‘255’ of the eight table data output from the second comparator circuit 620. Since the CMY tone value is smaller than the medium value, the third comparator circuit 630 selects four table data of not greater than the medium value among the eight table data and transfers the selected four table data to the fourth comparator circuit 640. The third comparator circuit 630 also outputs a resulting bit ‘0’ as the comparison result and adds this resulting bit to the end of the 2-bit resulting bit data output from the second comparator circuit 620. The third comparator circuit 630 accordingly outputs 3-bit resulting bit data ‘110’.

FIG. 28(d) shows the result of comparison between the four table data input into the fourth comparator circuit 640 and the CMY tone value ‘240’. The fourth comparator circuit 640 having the circuit structure of FIG. 26 compares the CMY tone value ‘240’ with a medium value ‘255’ of the four table data output from the third comparator circuit 630. Since the CMY tone value is smaller than the medium value, the fourth comparator circuit 640 selects two table data of not greater than the medium value among the four table data and transfers the selected two table data to the fifth comparator circuit 650. The fourth comparator circuit 640 also outputs a resulting bit ‘0’ as the comparison result and adds this resulting bit to the end of the 3-bit resulting bit data output from the third comparator circuit 630. The fourth comparator circuit 640 accordingly outputs 4-bit resulting bit data ‘1100’.

FIG. 28(e) shows the result of comparison between the two table data input into the fifth comparison circuit 650 and the CMY tone value ‘240’. The fifth comparator circuit 650 having the circuit structure of FIG. 27 compares the CMY tone value ‘240’ with a medium value ‘238’ of the two table data output from the fourth comparator circuit 640. Since the CMY tone value is greater than the medium value, the fifth comparator circuit 650 selects table data ‘255’ of greater than the medium value between the two table data. The fifth comparator circuit 650 also outputs a resulting bit ‘1’ as the comparison result and adds this resulting bit to the end of the 4-bit resulting bit data output from the fourth comparator circuit 640. The fifth comparator circuit 650 accordingly outputs 5-bit resulting bit data ‘11001’.

The binary number ‘11001’ is equivalent to a decimal number ‘25’. The encoded value search unit 600 accordingly outputs an encoded value ‘25’. As shown in FIG. 28(a), encoded values ‘0’ to ‘31’ are allocated in an ascending order to the thirty two table data. The table data ‘255’ selected by the fifth comparator circuit 650 has the allocated encoded value ‘25’. Namely the encoded value search unit 600 compares an input tone value with a medium value of multiple table data and sequentially halves the number of table data according to the comparison result to eventually determine an encoded value.

In the circuit structure of the encoded value search unit 600 described above, the five comparator circuits 610 to 650 are connected in a pipeline manner to sequentially transfer the selected table data and the resulting bit data. This arrangement enables the encoding process in the unit of one clock and thus significantly enhances the processing speed of the printing process. The encoding process is implemented by the simple circuit structure as the combination of the multiple circuits including the comparator and the separators. This simple circuit structure is readily incorporated in the image processing ASIC 155.

As described previously with reference to FIG. 12, all the elements are set to ‘255’ on the start of generation of the encoding table ET. This keeps the arrangement of table data in the ascending order and ensures smooth comparison between the CMY tone value and the table data by the respective comparators.

The encoded value search unit 600 of the modified example has the five comparator circuits 610 to 650. The required number of comparator circuits depends upon the number of table data simultaneously input into the encoded value search unit 600. The encoding process sequentially halves the number of table data and eventually selects one table data. When the number of table data is 2̂n, the number of halving operations is n times. In general, ‘n’ comparator circuits are required for processing 2̂n table data.

In the modified example described above, the first comparator circuit 610 inputs the even number (32) of table data. Strictly speaking, there is accordingly no medium value. The 16^{th} smallest table data is used as the medium value in the above description. This is, however, not restrictive, but 17^{th} smallest table data may be used as the medium value. In this case, conditional equations of the respective comparators and the boundaries of halving the number of table data are adequately set to give the encoded value. The encoded value may be determined according to data at any arbitrary position, instead of a medium value of a numeric sequence by adequately adjusting the method of comparison by respective comparators, the method of reducing the number of data, and the method of determining a resulting bit.

As described above with reference to FIGS. 22 through 28, the circuit structure of the modified example uses multiple comparator circuits to successively halve the number of table data. This circuit structure is, however, not restrictive. One modified circuit structure adopted to halve the number of table data may use only one comparator circuit and latch the output of the comparator circuit to be recursively input into the comparator circuit. In this modified structure, the position of a register for storage of a medium value and the effective selectors used for the processing are changed at each operation time of halving the number of table data.

The embodiment and its modifications discussed above are to be considered in all aspects as illustrative and not restrictive. There may be many modifications, changes, aspects, and alterations without departing from the scope or spirit of the main characteristics of the present invention. For example, the functions by the hardware configuration of the image processing ASIC 155 may be actualized by the software configuration in execution of a predetermined program by the CPU 151.

### (F) Other Aspects

In one preferable application of the image processing device according to the above aspect of the invention, the comparison module has a comparator configured to output a value ‘1’ as a resulting bit representing a result of each comparison when the comparison target value is greater than the medium value and output a value ‘0’ as the resulting bit when the comparison target value is not greater than the medium value. The encoding module specifies the encoded value, based on the resulting bit representing the result of each comparison. This arrangement enables the encoding module to readily specify the encoded value according to the resulting bit output from the comparator.

In one preferable structure of the image processing device of this application, the comparison module has a selector configured to, in response to the resulting bit equal to ‘1’, selectively leave representative tone values of greater than the medium value in the numeric sequence and in response to the resulting bit equal to ‘0’, selectively leave representative tone values of not greater than the medium value in the numeric sequence. This arrangement enables the comparison module to readily select the representative tone values for a subsequent comparison according to the resulting bit.

In a further preferable structure of the image processing device of this application, the comparison module has a specific number of the selectors corresponding to a repeated number of the comparisons. The selectors are connected in series. Each of the selectors transfers a numeric sequence consisting of the left representative tone values to a subsequent selector connected in series immediately after the selector, and the subsequent selector makes the selection with the transferred numeric sequence. This arrangement subtracts the number of the representative tone values included in the numeric sequence in the pipeline manner and thus enhances the processing speed of specifying the encoded value.

In a still preferable structure of the image processing device of this application, the comparison module has a specific number of the comparators corresponding to the specific number of the selectors. Each of the comparators compares the comparison target value with a medium value of the numeric sequence transferred to the corresponding selector. This arrangement enables the comparison in the pipeline manner and thus further enhances the processing speed.

In another preferable application of the image processing device according to the above aspect of the invention, the numeric sequence input from the encoding table consists of 2̂n representative tone values. The encoding module arrays ‘n’ resulting bits output from the comparator in an output order from its upper bit position and specifies a value expressed by the arrayed ‘n’ resulting bits as the encoded value. This arrangement readily specifies the encoded value by simply arraying the resulting bits.

According to another aspect, the invention is directed to a printing device including: an image processing device having any of the above arrangements; and a dot formation mechanism of forming dots on the printing medium according to the determined arrangement of dots.

Still another aspect of the invention pertains to a search device of comparing a numeric sequence of 2̂n numeric values arranged in an ascending order with a comparison target value as an object of comparison and searching for an ordinal number of a minimum numeric value out of numeric values of equal to or greater than the comparison target value in the numeric sequence.

The search device includes: an input module configured to input the numeric sequence and the comparison target value; a comparator configured to compare the comparison target value with a medium value of the numeric sequence and output a value ‘1’ as a resulting bit representing a result of the comparison when the comparison target value is greater than the medium value while outputting a value ‘0’ as the resulting bit when the comparison target value is not greater than the medium value; a selector configured to, in response to the resulting bit equal to ‘1’, select numeric values of greater than the medium value in the numeric sequence and in response to resulting bit equal to ‘0’, select numeric values of not greater than the medium value in the numeric sequence; and an output module configured to make the comparator and the selector repeat the comparison and the selection a total of ‘n’ times while making a numeric sequence of the selected numeric values input into the input unit to sequentially halve the number of the numeric values included in the numeric sequence, array ‘n’ resulting bits output from the comparator in an output order from its upper bit position, and output the arrayed ‘n’ resulting bits as the ordinal number.

The search device according to this aspect of the invention enables an ordinal number of a desired numeric value to be readily searched among 2̂n numeric values arranged in an ascending order.

In one preferable application according to this aspect of the invention, the search device has ‘n’ selectors, which are connected in series. Each of the ‘n’ selectors transfers the numeric sequence of the selected numeric values to a subsequent selector connected in series immediately after the selector, and the subsequent selector makes the selection with the transferred numeric sequence. This arrangement subtracts the number of the numeric values included in the numeric sequence in the pipeline manner and thus enhances the search speed.

In a preferable structure of this application, the search device has ‘n’ comparators corresponding to the ‘n’ selectors. Each of the ‘n’ comparators inputs a medium value of the numeric sequence transferred to the corresponding selector and compares the input medium value with the comparison target value. This arrangement enables the comparison in the pipeline manner and thus further enhances the processing speed.

What is claimed is:

1. An image processing device of determining an arrangement of dots, based on a dither matrix having a record of threshold values used for determining a dot formation state in each of pixels constituting image data according to a tone value of the pixel,
the image processing device comprising:
an encoding table generation module configured to divide the dither matrix into multiple blocks, each including a preset number of plural threshold values, and sequentially compare each tone value with threshold values included in each block in an allowable range of the tone value in an ascending order, so as to generate an encoding table of recording a correlation of an encoded value representing an arrangement of dots in one block to a representative tone value;
an image data input module configured to input image data;
a block position identification module configured to identify a block position in the dither matrix corresponding to each pixel, based on a position of the pixel in the input image data and positions of the respective blocks in the dither matrix;
a table data input module configured to input a tone value of each pixel as a comparison target value and input a numeric sequence of multiple representative tone values correlated to a block position identified corresponding to the pixel from the encoding table;
a comparison module configured to compare the comparison target value of each pixel with a medium value of the numeric sequence correlated to the identified block position and repeat comparison between the comparison target value with a successively specified medium value of the numeric sequence while sequentially halving the number of the representative tone values included in the numeric sequence on a boundary of the medium value;
an encoding module configured to specify an encoded value of each pixel according to a result of the repeated comparisons; and
a decoding module configured to determine an arrangement of dots to be formed in a block corresponding to the position of each pixel, based on the specified encoded value of the pixel and the identified block position.

2. The image processing device in accordance with claim 1, wherein the comparison module has a comparator configured to output a value ‘1’ as a resulting bit representing a result of each comparison when the comparison target value is greater than the medium value and output a value ‘0’ as the resulting bit when the comparison target value is not greater than the medium value, and
the encoding module specifies the encoded value, based on the resulting bit representing the result of each comparison.

3. The image processing device in accordance with claim 2, wherein the comparison module has a selector configured to, in response to the resulting bit equal to ‘1’, selectively leave representative tone values of greater than the medium value in the numeric sequence and in response to the resulting bit equal to ‘0’, selectively leave representative tone values of not greater than the medium value in the numeric sequence.

4. The image processing device in accordance with claim 3, wherein the comparison module has a specific number of the selectors corresponding to a repeated number of the comparisons,
the selectors are connected in series, and
each of the selectors transfers a numeric sequence consisting of the left representative tone values to a subsequent selector connected in series immediately after the selector, and the subsequent selector makes the selection with the transferred numeric sequence.

5. The image processing device in accordance with claim 4, wherein the comparison module has a specific number of the comparators corresponding to the specific number of the selectors, and
each of the comparators compares the comparison target value with a medium value of the numeric sequence transferred to the corresponding selector.

6. The image processing device in accordance with claim 2, wherein the numeric sequence input from the encoding table consists of 2̂n representative tone values, and
the encoding module arrays ‘n’ resulting bits output from the comparator in an output order from its upper bit position and specifies a value expressed by the arrayed ‘n’ resulting bits as the encoded value.

7. A printing device, comprising:
the image processing device in accordance with claim 1; and
a dot formation mechanism of forming dots on the printing medium according to the determined arrangement of dots.

8. A search device of comparing a numeric sequence of 2̂n numeric values arranged in an ascending order with a comparison target value as an object of comparison and searching for an ordinal number of a minimum numeric value out of numeric values of equal to or greater than the comparison target value in the numeric sequence,
the search device comprising:
an input module configured to input the numeric sequence and the comparison target value;
a comparator configured to compare the comparison target value with a medium value of the numeric sequence and output a value ‘1’ as a resulting bit representing a result of the comparison when the comparison target value is greater than the medium value while outputting a value ‘0’ as the resulting bit when the comparison target value is not greater than the medium value;
a selector configured to, in response to the resulting bit equal to ‘1’, select numeric values of greater than the medium value in the numeric sequence and in response to resulting bit equal to ‘0’, select numeric values of not greater than the medium value in the numeric sequence; and
an output module configured to make the comparator and the selector repeat the comparison and the selection a total of ‘n’ times while making a numeric sequence of the selected numeric values input into the input unit to sequentially halve the number of the numeric values included in the numeric sequence, array ‘n’ resulting bits output from the comparator in an output order from its upper bit position, and output the arrayed ‘n’ resulting bits as the ordinal number.

9. The search device in accordance with claim 8, the search device having ‘n’ selectors, which are connected in series,
wherein each of the ‘n’ selectors transfers the numeric sequence of the selected numeric values to a subsequent selector connected in series immediately after the selector, and the subsequent selector makes the selection with the transferred numeric sequence.

10. The search device in accordance with claim 9, the search device having ‘n’ comparators corresponding to the ‘n’ selectors,
wherein each of the ‘n’ comparators inputs a medium value of the numeric sequence transferred to the corresponding selector and compares the input medium value with the comparison target value.

11. An image processing method of determining an arrangement of dots, based on a dither matrix having a record of threshold values used for determining a dot formation state in each of pixels constituting image data according to a tone value of the pixel,
the image processing method comprising:
dividing the dither matrix into multiple blocks, each including a preset number of plural threshold values, and sequentially comparing each tone value with threshold values included in each block in an allowable range of the tone value in an ascending order, so as to generate an encoding table of recording a correlation of an encoded value representing an arrangement of dots in one block to a representative tone value;
inputting image data;
identifying a block position in the dither matrix corresponding to each pixel, based on a position of the pixel in the input image data and positions of the respective blocks in the dither matrix;
inputting a tone value of each pixel as a comparison target value and inputting a numeric sequence of multiple representative tone values correlated to a block position identified corresponding to the pixel from the encoding table;
comparing the comparison target value of each pixel with a medium value of the numeric sequence correlated to the identified block position and repeating comparison between the comparison target value with a successively specified medium value of the numeric sequence while sequentially halving the number of the representative tone values included in the numeric sequence on a boundary of the medium value;
specifying an encoded value of each pixel according to a result of the repeated comparisons; and
determining an arrangement of dots to be formed in a block corresponding to the position of each pixel, based on the specified encoded value of the pixel and the identified block position.
